(19) United States
(12) Patent Application Publication
(10) Pub. No.: US 2026/0220425 A1
(43) Pub. Date: Jul. 30, 2026

(54) HIERARCHICAL MEMORY ATTENTION NETWORK WITH MULTI-COMPONENT WEIGHTED ATTENTION AND ADAPTIVE RESOURCE ALLOCATION

(71) Applicant: THE AI BRAIN COMPANY, INC., Woodbridge, VA (US)

(72) Inventor: Raakin Zain Iqbal, Dubai (AE)

(73) Assignee: THE AI BRAIN COMPANY, INC., Woodbridge, VA (US)

(21) Appl. No.: 19/462,621

(22) Filed: Jan. 28, 2026

Related U.S. Application Data
(60) Provisional application No. 63/751,316, filed on Jan. 30, 2025.

(51) Int. Cl. G06N 3/044; G06F 9/50; G06F 18/21

(52) U.S. Cl. CPC G06N 3/044; G06F 9/5027; G06F 18/217

(57) ABSTRACT

Systems, methods, and computer-readable media are disclosed for providing hierarchical processing in neural network architectures (e.g., transformer-based models, recurrent networks, state space models, memory-augmented networks, and retrieval-augmented systems), which may improve computational efficiency and memory utilization.

### CROSS-REFERENCE TO RELATED APPLICATION(S)

This application claims the benefit of prior filed U.S. Provisional Patent Application No. 63/751,316, filed Jan. 30, 2025, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to hierarchical memory attention networks, and, more particularly, to systems, methods, and computer-readable media for providing hierarchical processing in neural network architectures, including, but not limited to, transformer-based models, recurrent neural networks, state space models, memory-augmented networks, and retrieval-augmented systems.

### BACKGROUND OF THE DISCLOSURE

Natural language processing has become increasingly popular, and transformers are often used to train large language models on large language datasets. However, attention mechanisms of such transformers are often computationally inefficient.

### SUMMARY OF THE DISCLOSURE

This document describes systems, methods, and computer-readable media for providing hierarchical attention in neural network architectures (e.g., transformer-based models, recurrent networks, state space models, memory-augmented networks, and retrieval-augmented systems).

For example, a computer-implemented method is provided for hierarchical attention in transformer-based language models, the method configured to improve computational efficiency and memory utilization, and the method including (a) computing, for each memory unit u of a plurality of memory units in a hierarchical memory structure, the following: (i) an uncertainty component, Uncertainty(u), derived from entropy of attention probability distributions across the memory unit; (ii) a novelty component, Novelty(u), derived from layer-specific information content measurements computed independently at each transformer layer, wherein the novelty component represents cumulative surprise across multiple representation scales; and (iii) a coherence component, Coherence(u), derived from graph-based connectivity analysis measuring structural relationships between memory units of the plurality of memory units in the hierarchical memory structure; (b) combining the uncertainty, novelty, and coherence components using trainable weights α, β, and γ to produce a unified UNC attention score, UNC(u), for each memory unit u, according to: UNC(u)=α×Uncertainty(u)+β×Novelty(u)+γ×Coherence(u), wherein the weights α, β, and γ are optimizable parameters; (c) allocating computational and storage resources to each memory unit u based on its UNC attention score according to an inverse power-law allocation formula: A(s)=k×(1/s\hat{ }ρ), where s is the UNC attention score, k is a normalization constant, and ρ is a tunable exponent in the range [0.5, 2.0]; and (d) dynamically adjusting memory unit boundaries of the hierarchical memory structure using an adaptive threshold, threshold(t), computed via exponential moving average of historical UNC attention scores according to the following: threshold(t)=λ×UNC(t)+(1−λ)×threshold(t−1), wherein λ is an adaptation rate; and wherein: the method enables selective retention and prioritized processing of the plurality of memory units based on the combined uncertainty, novelty, and coherence components, thereby improving computational efficiency compared to uniform attention mechanisms.

As another example, there is provided a computer-implemented method for hierarchical attention in neural network architectures, the method configured to improve computational efficiency and memory utilization. The method includes (a) computing, for each memory unit u of a plurality of memory units in a hierarchical memory structure, an importance score by combining two or more distinct importance signals, wherein the distinct importance signals capture complementary aspects of content relevance and comprise at least two of the following: (i) an uncertainty component derived from entropy, confidence, variance, or statistical distribution analysis of attention patterns, gate activations, or state representations; (ii) a novelty component derived from layer-specific, position-specific, abstraction-level-specific, or time-specific information content, surprise, or divergence measurements; (iii) a coherence component derived from graph-based, structure-based, similarity-based, or relationship-based connectivity analysis; and (iv) any other distinct importance signal capturing a different aspect of content relevance; (b) allocating computational and storage resources to each memory unit u based on its importance score according to a monotonically decreasing allocation function; and (c) dynamically adjusting memory unit boundaries using an adaptive threshold mechanism; wherein the method enables selective retention and prioritized processing of the plurality of memory units based on the combined importance signals, thereby improving computational efficiency compared to uniform processing mechanisms.

As yet another example, there is provided a system for hierarchical processing in neural network architectures. The system includes (a) an importance computation module configured to compute importance scores for memory units by combining two or more distinct importance signals capturing complementary aspects of content relevance through weighted or learned combination mechanisms; (b) a resource allocation module configured to allocate computational and storage resources to memory units based on importance scores using any monotonically decreasing allocation function; (c) a boundary detection module configured to segment input into memory units using adaptive thresholding mechanisms, wherein segmentation may be based on discrete boundaries, temporal windows, state transitions, or any other suitable partitioning; (d) a hierarchical memory module configured to manage multi-tier storage with selective retention based on importance, comprising at least a high-fidelity tier and a low-fidelity tier; (e) a cross-tier relationship module configured to maintain relationships between memory units across tiers, enabling selective retrieval and resurrection of lower-tier content based on relationship strength; and (f) one or more processors configured to execute the above modules on any neural network architecture producing importance-relevant signals, comprising attention distributions, gating mechanism outputs, hidden state representations, selective coefficients, or memory access patterns.

As yet another example, there is provided a non-transitory computer-readable medium storing instructions that, when executed by one or more processors, cause the processors to perform a method for hierarchical processing in neural network architectures. The method includes computing importance scores for memory units by combining two or more distinct importance signals capturing complementary aspects of content relevance; allocating resources based on importance scores using a monotonically decreasing allocation function; dynamically adjusting memory unit boundaries using adaptive thresholding; managing hierarchical memory with selective retention; and maintaining cross-tier relationships enabling selective retrieval and resurrection.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for providing a model processing service, according to one or more embodiments of the disclosure;

FIG. 1A is a more detailed schematic view of a subsystem of the system of FIG. 1, according to one or more embodiments of the disclosure;

FIG. 1B is a schematic view of a system architecture of a hierarchical memory attention network, according to one or more embodiments of the disclosure;

FIG. 2 illustrates a flowchart of an exemplary process for computing an uncertainty, novelty, coherence (“UNC”) score, according to one or more embodiments of the disclosure;

FIG. 3 illustrates a flowchart of an exemplary process for detecting memory unit boundaries, according to one or more embodiments of the disclosure;

FIG. 4 illustrates a flowchart of an exemplary process for allocating memory resources, according to one or more embodiments of the disclosure;

FIG. 5 is a schematic view of an architecture of a three-tier memory structure with coherence links, according to one or more embodiments of the disclosure; and

FIG. 6 illustrates a flowchart of an exemplary process for query processing, according to one or more embodiments of the disclosure.

### DETAILED DESCRIPTION OF THE DISCLOSURE

The present disclosure provides a family of methods and systems for hierarchical resource allocation in any neural network architecture producing importance-relevant signals including, but not limited to, attention distributions, gating mechanisms, hidden states, and/or state representations. While specific embodiments describe transformer-based language models as illustrative examples, the core innovations apply universally to various entities including, but not limited to, (a) any neural network with attention mechanisms (e.g., including, but not limited to, transformers, multi-head attention variants, cross-attention mechanisms, and self-attention variants); (b) any recurrent neural network (e.g., including, but not limited to, gated recurrent units (“GRUs”), long short-term memory networks (“LSTMs”), and variants with attention augmentation); (c) any state space model (e.g., including, but not limited to, Mamba, structured state space sequence (“S4”) model, simplified structured state space sequence model (“S5”), and selective state space variants); (d) any memory-augmented architecture (e.g., including, but not limited to, neural Turing machines, differentiable neural computers, and memory networks); (e) any retrieval-augmented system (e.g., including, but not limited to, retrieval-augmented generation (“RAG”) pipelines, dense retrieval, sparse retrieval, hybrid retrieval, and learned retrieval); (f) any hybrid or future architecture combining elements of the above, and/or the like. References to specific architectures, specific parameters, or specific implementation details are intended as non-limiting illustrative embodiments only. The mathematical principles disclosed herein (e.g., multi-component importance scoring using distinct complementary signals, inverse-relationship resource allocation, adaptive thresholding, cross-tier relationship management, etc.) may be architecture-agnostic, framework-independent, and implementation-neutral. This scope breadth is integral to the disclosure's value and should inform claim construction in prosecution and litigation.

The present disclosure relates generally to hierarchical memory attention networks, hierarchical memory attention networks with multi-component weighted attention and adaptive resource allocation, surprise-driven hierarchical memory attention networks with dynamic context compression, and/or the like. Systems, methods, and computer-readable media are disclosed for providing hierarchical attention in transformer-based models (e.g., transformer-based language models), which may improve computational efficiency and memory utilization. This disclosure describes a transformer-based architecture combining episodic memory formation, Bayesian surprise metrics, and graph-theoretic boundary refinement to enable efficient long-context processing. This may be configured to dynamically segment input streams into memory units using computational neuroscience principles and then apply hierarchical attention across these units for context-aware reasoning. This disclosure describes a neural network architecture that may integrate surprise-driven episodic memory formation with multi-level attention mechanism(s) for efficient long-sequence processing. This may employ Bayesian surprise detection (e.g., for segmenting input streams into memory units), graph-theoretic boundary refinement (e.g., for optimizing memory cohesion), two-stage hybrid retrieval (e.g., for combining similarity and temporal criteria), and/or hierarchical attention (e.g., for coupling episodic memory with token-level processing). This may provide numerous innovations, including, but not limited to, adaptive memory compression (e.g., O(n) complexity vs. O(n²)), dynamic context window management, and/or surprise-based memory prioritization, which may provide significantly faster inference (e.g., 4.6 times faster inference) and/or significantly improved memory reduction (e.g., 7.5 times memory reduction) compared to other transformer architectures. System integration may include chunked prefill with dynamic cache management (e.g., key-value (“KV”) cache management), parallel processing across clusters (e.g., graphics processing unit (“GPU”) clusters), and/or the like. Systems and methods of this disclosure may be provided for various use cases, including, but not limited to, real-time analytics, autonomous systems, medical artificial intelligence (“AI”), and/or the like. For example, systems and methods of this disclosure may provide real-time analytics, such as the ability to process 1 million token documents with a latency of only 89 ms may allow for real-time analysis of massive datasets, such as social media feeds or financial markets, thereby enabling immediate insights and timely decision-making. As another example, systems and methods of this disclosure may provide for autonomous systems, such as energy-efficient context tracking (e.g., tracking at 2.1 W for 10,000 tokens), which may be crucial for autonomous systems (e.g., self-driving cars, drones, etc.) where battery life and real-time processing may be critical, and such efficiency may allow for continuous environmental awareness and adaptation. As yet another example, systems and methods of this disclosure may provide medical AI, such as dynamic focus of longitudinal patient record analysis, whereby a system can adapt its attention to the most relevant information in a patient's history, potentially leading to more accurate diagnoses and personalized treatment plans, and whereby such solutions may be particularly valuable for conditions with long and complex medical histories. Therefore, systems and methods of this disclosure may provide surprise-driven memory formation (e.g., as opposed to fixed temporal hierarchy), graph-optimized boundaries (e.g., as opposed to static partitions), and/or hybrid attention-retrieval (e.g., as opposed to gated self-attention).

This disclosure further develops and expands upon the surprise-driven memory formation concepts disclosed in U.S. Provisional Patent Application No. 63/751,316, introducing an Uncertainty, Novelty, Coherence (“UNC”) attention mechanism as an implementation of Bayesian surprise metrics. The “surprise-driven” terminology in U.S. Provisional Patent Application No. 63/751,316 may correspond directly to an UNC scoring mechanism described herein.

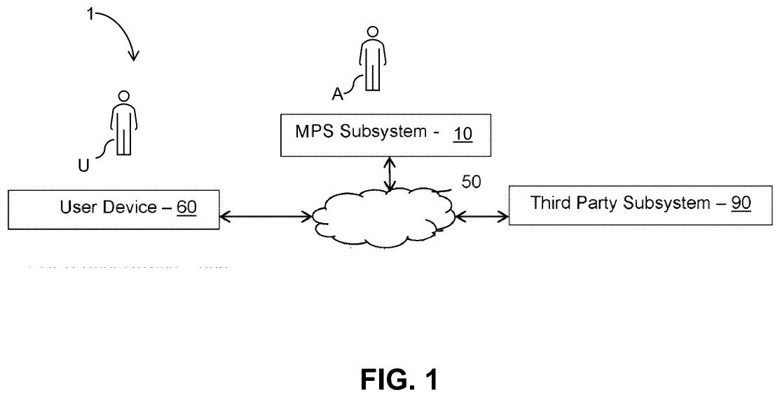

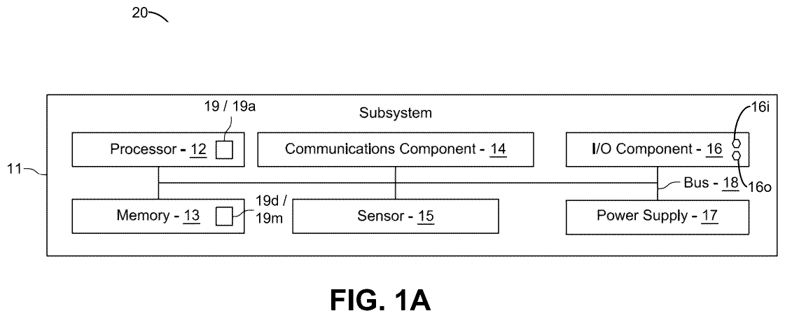

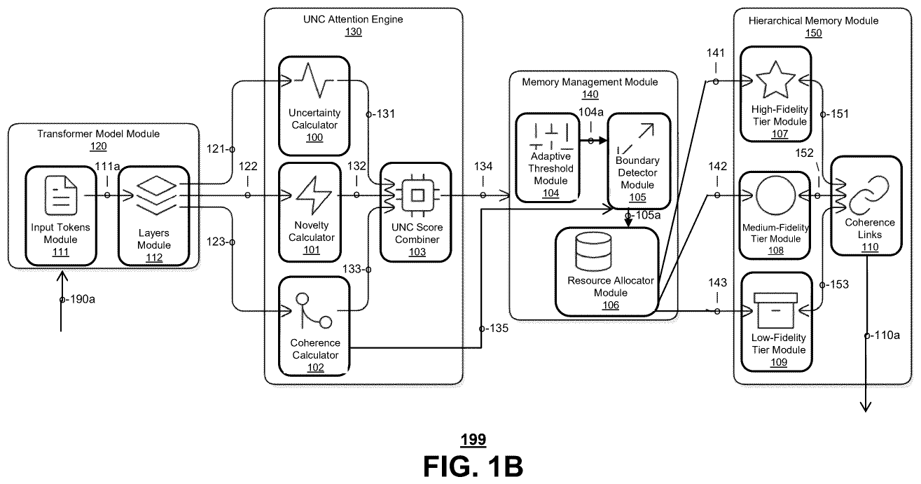

### FIGS. 1 and 1A

FIG. 1 is a schematic view of an illustrative system 1 in which transformer model training and querying may be facilitated utilizing any suitable subsystem(s), user device(s), and/or the like. For example, as shown in FIG. 1, system 1 may include a model processing service (“MPS”) subsystem 10, at least one user subsystem or user device 60, at least one third party enabler subsystem 90, and at least one communications network 50 through which MPS subsystem 10 and at least one user device 60 and/or at least one third party enabler subsystem 90 may communicate. Some or all portions of MPS subsystem 10 may be operated, managed, or otherwise at least partially controlled by any suitable entity (e.g., an administrator A) that may be responsible for providing to one or more other entities (e.g., a user U) of system 1 a model processing service or model processing service platform (“MPSP”).

As shown in FIG. 1A, a subsystem or system device 20 (e.g., one, some, or each of the devices and/or subsystems described herein of FIG. 1 (e.g., device 60, subsystem 10, subsystem 90, and/or otherwise) may include any suitable components or modules, including, but not limited to, a processor component 12, a memory component 13, a communications component 14, a sensor 15, an input/output (“I/O”) component 16, a power supply component 17, a housing 11, and/or a bus 18 that may provide one or more wired or wireless communication links or paths for transferring data and/or power to, from, or between various other components of subsystem 20. In some embodiments, one or more components of subsystem 20 may be combined or omitted. Moreover, subsystem 20 may include other components not combined or included in FIG. 1A and/or several instances of the components shown in FIG. 1A. For the sake of simplicity, only one of each of the components of subsystem 20 is shown in FIG. 1A.

I/O component 16 may include at least one input component 16i (e.g., a button, mouse, keyboard, etc.) to receive information from a user or other device or power therefrom and/or at least one output component 16o (e.g., an audio output component or speaker, video output component or display, haptic output component (e.g., rumbler, vibrator, etc.), lighting output component, olfactory output component, movement actuator, etc.) to provide information or power or any other suitable support to a user or other device, such as a touch screen I/O component that may receive input information through a user's touch of a display screen and that may also provide visual information to a user via that same display screen, and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like.

Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 19d (e.g., unique user identifier information, parameters, models, neural networks, algorithms, application data, etc.) and/or any suitable service system management model 19m (e.g., any suitable transformer model that may be trained and/or queried by the MPSP (e.g., any suitable transformer-based language model (e.g., that may be used by any suitable application 19a))) Memory 13 may include suitable logic, circuitry, and/or code that may enable storage of various types of information, such as received data, generated data, code, and/or configuration information.

Communications component 14 may be provided to allow subsystem 20 to communicate with one or more other subsystems 20 (e.g., any communication to, from, and/or between subsystem(s) 10, 60, 90, and/or the like of system 1 (e.g., via any suitable network 50)) using any suitable communications protocol(s). Communications component 14 can be operative to create or connect to a communication network or link of a network. Communications component 14 can provide wireless communications using any suitable short-range or long-range communications protocol, such as Wi-Fi (e.g., an 802.11 protocol), ZigBee™ (e.g., an 802.15.4 protocol), WiDi™, Ethernet, Bluetooth™ Low Energy (“BLE”), ultra-wideband, radio frequency systems (e.g., 1200 MHz, 2.4 GHz, and 5.6 GHZ communication systems), high frequency systems (e.g., 900 MHz, 2.4 GHz, and 5.6 GHz communication systems), near field communication (“NFC”), infrared, protocols used by wireless and cellular telephones and personal e-mail devices, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any other communications protocol, or any combination thereof. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access. Communications component 14 may also include or may be electrically coupled to any suitable transceiver circuitry that can enable subsystem 20 to be communicatively coupled to another subsystem and communicate data with that other device wirelessly or via a wired connection (e.g., using a connector port). Communications component 14 (and/or sensor assembly 15) may be configured to determine a geographical position of subsystem 20 and/or any suitable data that may be associated with that position. For example, communications component 14 may utilize a global positioning system (“GPS”) or a regional or site-wide positioning system that may use cell tower positioning technology or Wi-Fi™ technology, or any suitable location-based service or real-time locating system, which may use a geo-fence for providing any suitable location-based data to subsystem 20 (e.g., to determine a current geo-location of subsystem 20 and/or any other suitable associated data). Communications component 14 may include or otherwise provide a network interface that may include mechanical, electrical, and/or signaling circuitry for communicating any suitable data over any suitable physical links that may be coupled to network 50.

Sensor 15 may be any suitable sensor that may be configured to sense any suitable data for subsystem 20 (e.g., location-based data via a global positioning system (“GPS”) sensor system or any other suitable location determination protocol, motion data, environmental data, biometric data, etc.). Sensor 15 may be a sensor assembly that may include any suitable sensor or any suitable combination of sensors operative to detect movements of subsystem 20 and/or of any user thereof and/or any other characteristics of subsystem 20 and/or of its environment (e.g., physical activity or other characteristics of a user of subsystem 20, light content of the device environment, gas pollution content of the device environment, noise pollution content of the device environment, altitude of the device, etc.).

Power supply 17 can include any suitable circuitry for receiving and/or generating power, and for providing such power to one or more of the other components of subsystem 20. For example, power supply assembly 17 can be coupled to a power grid (e.g., when subsystem 20 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 20 is acting as a portable device). Subsystem 20 may also be provided with a housing 11 that may at least partially enclose one or more of the components of subsystem 20 for protection from debris and other degrading forces external to subsystem 20. Each component of subsystem 20 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 20 may include other components not combined or included in those shown or several instances of the components shown.

Processor 12 may be used to run one or more applications, such as an application 19 (e.g., application 19a) that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem 90 and/or by MPS subsystem 10 for enabling user device 60 to interact with an online service), application programming interfaces (“APIs”), software development kits (“SDKs”), MPS applications (e.g., a web application or a native application that may be at least partially produced by MPS subsystem 10 for enabling user device 60 to interact with an online service (e.g., a model training service and/or a model querying service) and/or a third party subsystem 90), any other suitable applications, and/or the like. For example, processor 12 may load an application 19 as an interface program to determine how instructions or data received via an input component 16i of I/O component 16 or other component of subsystem 20 (e.g., sensor 15 and/or communications component 14) may manipulate the way in which information may be stored (e.g., in memory 13) and/or provided to via an output component 160 of I/O component 16 and/or to another system device via communications component 14. As one example, application 19 may be a third party application that may be running on subsystem 20 that may be loaded on subsystem 20 (e.g., using communications component 14) via an application market, such as the Apple App Store or Google Play, or that may be accessed via an internet application or web browser (e.g., by Apple Safari or Google Chrome) that may be running on subsystem 20 and that may be pointed to a uniform resource locator (“URL”) whose target or web resource may be managed by or otherwise affiliated with any suitable entity. Any device (e.g., any user device or subsystem or server) may include any suitable special purpose hardware (e.g., hardware support of high-speed packet processing, hardware support of machine learning algorithms, etc.). Processor 12 may include suitable logic, circuitry, and/or code that may enable processing data and/or controlling operations of subsystem 20. In this regard, processor 12 may be enabled to provide control signals to various other components of subsystem 20. Processor 12 may also control transfers of data between various portions of subsystem 20. Processor 12 may further implement an operating system or may otherwise execute code to manage operations of subsystem 20. As one example, application 19 may provide a user with the ability to interact with a model processing service platform (“MPSP”) of system 1, where application 19 may be a third party application that may be running on user device 60 (e.g., an application associated with MPS subsystem 10 and/or third party subsystem 90) that may be loaded on user device 60 (e.g., using communications component 14) via an application market, such as the Apple App Store or Google Play, or that may be accessed via an internet application or web browser (e.g., by Apple Safari or Google Chrome) that may be running on user device 60 and that may be pointed to a uniform resource locator (“URL”) whose target or web resource may be managed by or otherwise affiliated with the MPSP.

Subsystem 20 may be any portable, mobile, wearable, implantable, or hand-held electronic device configured to operate with system 1. Alternatively, subsystem 20 may not be portable during use, but may instead be generally stationary. Subsystem 20 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), a tag, credit card-shaped device, transponder, transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., watch, ring, glasses, etc.), boom box, internet of things (“IoT”) device, virtualized IoT device (e.g., cloud compute instance), modem, router, RFID card, printer, kiosk, beacon (e.g., a Bluetooth low energy beacon transmitter device), server, and any combinations thereof. Subsystem 20 may be configured to have any physical structure (e.g., by one or more housings 11) that may include, but is not limited to, any suitable portable, mobile, wearable, implantable, rideable, controllable, or hand-held mobile electronic device (e.g., a portable and/or handheld media player), a headset, a helmet, glasses, a wearable, a tablet computer, a laptop computer, a controller, a VR and/or AR and/or MR device, a vehicle, server, sensor system, actuator system, and/or any other machine or device or housing or structure. Alternatively, subsystem 20 may not be portable during use, but may instead be generally stationary. In one or more implementations, one or more of processor 12, memory 13, sensor(s) 15, communications interface or communications component 14, I/O component 16, and/or power supply 17, and/or one or more portions thereof, may be implemented in software (e.g., subroutines and code), may be implemented in hardware (e.g., an application specific integrated circuit (“ASIC”), a field programmable gate array (“FPGA”), a programmable logic device (“PLD”), a controller, a state machine, gated logic, discrete hardware components, or any other suitable devices), and/or a combination of both. Variations in the arrangement and type of the components may be made without departing from the spirit or scope of the claims as set forth herein. Additional components, different components, or fewer components may be provided.

MPS subsystem 10 may communicate with one or more user devices 60 and/or third party enabler subsystem(s) 90 via one or more communications networks 50, and/or any user device 60 may communicate with any other user device 60 and/or subsystem 90 via one or more communications networks 50. Network 50 may be the internet or any other network for communicatively coupling any two entities or devices or subsystems of system 1 that may be remote from one another, such that when interconnected, a user device 60 may access information (e.g., an API, SDK, protocol, application, etc. (e.g., from data structure 19d of MPS subsystem 10, as may be provided as a validation processing service via processor 12 of MPS subsystem 10)) as if such information were stored locally at that user device (e.g., in memory component 13 of that device).

A user U of user device 60 and/or an operator of subsystem 10 may be configured to select any suitable input document(s) to be used for training any suitable model(s) of the MPSP and/or to select any suitable query to be used for querying a trained model of the MPSP (e.g., any suitable model 19m (e.g., that may be stored locally on user device 60, accessed from subsystem 10, and/or the like), such as any suitable transformer model that may be trained and/or queried by the MPSP (e.g., any suitable transformer-based language model)).

Any suitable model 19m may be developed and/or generated for use in processing any suitable query. For example, a model may be a learning engine, where the learning engine may be operative to use any suitable machine learning (“ML”) (e.g., the system's ability to learn automatically from past events to affect future behavior) to use a certain query to generate a final query response. For example, the learning engine may include any suitable neural network (e.g., an artificial neural network) that may be initially configured, trained on one or more input documents, and then used to respond to any suitable query.

A neural network or neuronal network or artificial neural network may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or query response prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

The initial configuring of the learning engine or management model for a particular system (e.g., the initial weighting and arranging of neurons of a neural network of the learning engine) may be done using any suitable data accessible to a custodian of the model (e.g., an administrator or user), such as data associated with the configuration of other learning engines of the system (e.g., learning engines or management models for other systems), data associated with the particular system (e.g., initial background data accessible by the model custodian about the particular system composition, location, past uses, and/or the like), data assumed or inferred by the model custodian using any suitable guidance, and/or the like. For example, a model custodian may be operative to capture any suitable initial background data about a particular system in any suitable manner, which may be enabled by any suitable user interface provided to an appropriate subsystem or device accessible to one, some, or each operator or entity with knowledge of the particular system (e.g., a model app or website). The model custodian may provide a data collection portal for enabling any suitable entity to provide initial background data for the particular system. The data may be uploaded in bulk or manually entered in any suitable manner.

A learning engine or model for a MPS system may be trained on any suitable input document(s) or the like. Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network.

A trained model may then receive input data (e.g., any suitable query) from any suitable source (e.g., user device, MPS subsystem, third party subsystem, etc.) using any suitable methods for use by the model. The trained model may then use this new input data to generate output data using the learning engine or model.

The processing power and speed of any suitable MPS system and its one or more models may be configured to train a model effectively and efficiently and/or to determine a response to a received query effectively and efficiently or otherwise adjust a managed element based on the determined query response automatically and instantaneously or substantially instantaneously based on any new received query, such that management of the system may run quickly and smoothly. This may enable the system to operate as effectively and as efficiently as possible.

Therefore, any suitable model custodian may be operative to generate and/or manage any suitable model or learning engine that may utilize any suitable machine learning, such as one or more artificial neural networks, to analyze certain input document data for training a model and/or to analyze certain query data for using a trained model to generate a query response that may be utilized in any way to adjust a functionality of a user device or otherwise, which may enable intelligent suggestions to be provided to an operator/user and/or intelligent system functionality adjustments to be made for improving the operator's/user's experiences and the system's productivity.

The use of one or more suitable models or engines or neural networks or the like may enable query response. Such models (e.g., neural networks) running on any suitable processing units (e.g., graphical processing units (“GPUs”) that may be available to the system) provide significant speed improvements in efficiency and accuracy with respect to query response over other types of algorithms and human-conducted analysis of data, as such models can provide estimates in a few milliseconds or less, thereby improving the functionality of any computing device on which they may be run. Due to such efficiency and accuracy, such models enable a technical solution for enabling the generation of any suitable control data (e.g., for controlling any suitable functionality of any suitable managed element) using any suitable real-time data (e.g., data made available to the models) that may not be possible without the use of such models, as such models may increase performance of their computing device(s) by requiring less memory, providing faster response times, and/or increased accuracy and/or reliability. Due to the condensed timeframe and/or the time within which a decision (e.g., query response) with respect to system data (e.g., received query) ought to be made to provide a desirable user experience, such models offer the unique ability to provide accurate responses with the speed necessary to enable effective and efficient use management. For example, as described herein, a model processing service of the disclosure enables various types of significant improvement in various types of computer functionality, including, but not limited to, computational complexity (e.g., O(n log n) as opposed to O(n²)), inference speed (e.g., 4.6× faster), memory consumption (e.g., 7.5× reduction), information retention (e.g., 75% as opposed to 35% (e.g., for 100,000 tokens)), and/or the like.

### FIG. 1B

FIG. 1B may show exemplary system architecture of a system 199 for providing any suitable hierarchical memory attention network, such as a hierarchical memory attention network with multi-component weighted attention and adaptive resource allocation and/or a surprise-driven hierarchical memory attention network with dynamic context compression. As shown, system 199 may provide any suitable network (e.g., a surprise-driven hierarchical memory attention network) that may include any suitable transformer or transformer module or transformer model or transformer model module 120, any suitable UNC attention engine module or UNC attention engine 130, any suitable memory management module 140, and any suitable hierarchical memory module or hierarchical memory 150. While “surprise-driven” may refer to a high-level goal of certain architectures, UNC may refer to specific implementations that may combine uncertainty, novelty, and coherence. A UNC mechanism may be a quantifiable implementation of Bayesian surprise metrics. This may apply to any architecture producing importance-relevant signals (e.g., transformers (e.g., attention distributions), recurrent neural networks (“RNNs”) (e.g., gate activations), state space models (“SSMs”) (e.g., selective coefficients), memory networks (e.g., access patterns), RAG systems (e.g., retrieval scores), etc.).

Transformer model module 120 may include any suitable input tokens module or component 111 and/or any suitable layers (e.g., attention layers or transformer layers) module or component 112, where elements 111 and 112 may represent the input processing and attention computation stages of system 199. Transformer model module 120 may be configured to receive any suitable input data 190a and generate any suitable data, including, but not limited to, data 121, data 122, and data 123. Transformer model module 120 may encompass a base neural network architecture that may process input tokens and generate attention distributions. Transformer model module 120 may represent a pre-trained or fine-tuned transformer-based language model (e.g., any suitable architecture (e.g., generative pre-trained transformer (“GPT”), bidirectional encoder representations from transformers (“BERT”), large language model meta AI (“Llama”), etc.) that may serve as the foundation for system 199 (e.g., a hierarchical memory attention system), such as for enabling natural language processing (“NLP”). Transformer model module 120 may receive any suitable input data 190a, which may be indicative of any suitable information, including, but not limited to, raw text input converted to token identifiers (“IDs”), positional encodings, optional pre-computed embeddings from prior context, and/or the like. The source and/or interface for enabling the provision of such input data may be architecture-agnostic (e.g., any user, application, and/or pipeline through any suitable interface (e.g., APIs, command-line interfaces (“CLIs”), graphical user interfaces (“GUIs”), streaming, batch, RAG pipelines, etc.)). System 199 may operate on importance-relevant signals (e.g., attention distributions, gate activations, state representations, selective coefficients, etc.) regardless of framework or deployment. Transformer model module 120 may be configured to carry out any suitable processing, including, but not limited to, token embedding lookup, positional encoding addition, multi-head self-attention computation across L layers, feed-forward network transformations, layer normalization at each stage, and/or the like. Therefore, transformer model module 120 may be configured to receive raw text input and/or converted token identifiers and positional encodings (e.g., as data 190a) and output any suitable data 121-123, which may be indicative of any suitable information, including, but not limited to, attention distributions or attention probability distributions (e.g., attention probability distributions A[batch, heads, seq, seq]) to UNC attention engine 130, hidden state representations (e.g., hidden state representations h_1 for each layer 1) or layer-specific hidden states (e.g., for novelty computation), final logits for next-token prediction, and/or the like.

Input tokens component 111 may be configured to receive raw text input and convert it into a sequence of token identifiers using any suitable tokenization algorithm (e.g., byte pair encoding (“BPE”), WordPiece, SentencePiece, etc.). Additionally or alternatively, input tokens component 111 may be configured to handle special tokens, padding, and sequence length management. For example, input tokens component 111 may be configured to receive any suitable input data (e.g., as data 190a), including, but not limited to, any suitable raw text string or document, any suitable tokenizer vocabulary V (e.g., typically 32K-100K tokens or any other suitable magnitude), any suitable maximum sequence length L_max, any suitable special token definitions (e.g., classification token for sentence-level tasks (“[CLS]”), separator token to divide text segments (“[SEP]”), padding token to create uniform sequence lengths (“[PAD]”), etc.), and/or the like. Input tokens component 111 may be configured to carry out any suitable processing, including, but not limited to, any suitable text normalization (e.g., unicode, whitespace), any suitable subword tokenization (e.g., via a trained tokenizer), any suitable token ID lookup from vocabulary, any suitable padding/truncation to L_max, any suitable special token insertion at sequence boundaries, and/or the like. Therefore, input tokens component 111 may be configured to receive such input data 190a and output any suitable data 111a, which may be indicative of any suitable information, including, but not limited to, any suitable token identifier sequence (e.g., a token ID sequence T=[t₁, t₂, . . . , tₙ], where tᵢ∈{0, 1, . . . , |V|−1}), any suitable attention mask (e.g., a mask that may be indicating valid vs. padded positions), any suitable token type IDs (e.g., for multi-segment inputs), and/or the like. Input tokens component 111 may serve as an entry point for transformer model module 120 and may provide any suitable output(s) to attention layers component 112 for embedding and processing and/or may provide any suitable token count (e.g., token count n) to be used throughout system 199 (e.g., for complexity calculations (e.g., O(n log n) computational complexity)).

Attention layers component 112 may be configured to implement the multi-layer transformer architecture with self-attention mechanisms. Each layer of any suitable number of layers of component 112 may be configured to compute attention distributions that may capture relationships between tokens, which may then be subsequently used by UNC attention engine 130 for uncertainty, novelty, and coherence analysis. For example, attention layers component 112 may be configured to receive any suitable input data (e.g., as data 111a), including, but not limited to, any suitable token embeddings (e.g., token embeddings E∈ [symbol] ^{n×d} from embedding lookup), any suitable positional encodings (e.g., positional encodings P∈ [symbol] ^{n×d}), any suitable layer-specific learned parameters (e.g., layer-specific learned parameters (W_Q, W_K, W_V, W_O per head per layer)), and/or the like. Attention layers component 112 may be configured to carry out any suitable processing, including, but not limited to, any suitable multi-head attention (e.g., multi-head attention: Q=XW_Q, K=XW_K, V=XW_V; Attention_1=softmax(QK\hat{ }T/√d_k)V), any suitable residual connection and layer norm, any suitable feed-forward network (e.g., feed-forward network: FFN(x)=max(0, xW₁+b₁)W₂+b₂), any suitable second residual and layer norm, and/or the like (e.g., for each layer 1∈{1, . . . , L}). Therefore, attention layers component 112 may be configured to receive such input data and output any suitable output data, which may be indicative of any suitable information, including, but not limited to, any suitable attention distributions or attention probability matrices (e.g., attention probability matrices A_1∈ [symbol] ^{n×n} for each layer 1) as data 121 for use by uncertainty component 100 of UNC attention engine 130, any suitable hidden states (e.g., hidden states h_1∈ [symbol] ^{n×d} for early/mid/late layers (e.g., h_early, h_mid, h_late, etc.) as data 122 for use by novelty component 101 of UNC attention engine 130, any suitable token embeddings (e.g., token embeddings E={e1, e2, . . . , en}) as data 123 for use by coherence component 102 of UNC attention engine 130, any suitable final layer output for next-token prediction, and/or the like. Outputs from input processing may flow to downstream components as appropriate for the architecture. Sequence length may be implicit in data structures. Final layer outputs may serve any suitable task-specific functions.

UNC attention engine 130 may include any suitable components or modules, including, but not limited to, any suitable uncertainty calculator or uncertainty component or uncertainty module 100 that may receive any suitable data 121 from transformer model module 120 and/or that may provide any suitable data 131, any suitable novelty calculator or novelty component or novelty module 101 that may receive any suitable data 122 from transformer model module 120 and/or that may provide any suitable data 132, any suitable coherence calculator or coherence component or coherence module 102 that may receive any suitable data 123 from transformer model module 120 and/or that may provide any suitable data 133, and/or any suitable UNC combiner or UNC combiner component or UNC combiner module 103 that may receive any suitable data 131, 132, and/or 133 and/or that may provide any suitable data 134. UNC attention engine 130 may be configured to group the various core scoring components (e.g., uncertainty, novelty, coherence) and their combiner (e.g., to provide such a novel three-component fusion). For example, UNC attention engine 130 may be configured to receive any suitable input data, including, but not limited to, any suitable attention distributions (e.g., from transformer module 120), any suitable hidden states from multiple layers, any suitable token embeddings for coherence analysis, and/or the like. UNC attention engine 130 may be configured to carry out any suitable processing, including, but not limited to, any suitable computation (e.g., parallel computation) of U (e.g., uncertainty or entropy), N (e.g., multi-layer novelty), and C (e.g., coherence (e.g., Fiedler coherence)), any suitable weighted combination (e.g., weighted combination via UNC(t)=α×U+β×N+γ×C), and/or the like. Therefore, UNC attention engine 130 may be configured to receive any suitable input data (e.g., attention distributions, hidden states, token embeddings, etc.) and output any suitable data, which may be indicative of any suitable information, including, but not limited to, any suitable combined UNC scores for each token position and/or any suitable individual component scores (U, N, C) for analysis (e.g., as data 134 for memory management module 140), any suitable Fiedler zero-crossings for boundary detection (e.g., as data 135 for memory management module 140), and/or the like.

Uncertainty component 100 may be configured to compute entropy-based uncertainty from attention distribution dispersion and/or to measure how spread out the attention probabilities are across the vocabulary for each token position. For example, uncertainty component 100 may be configured to receive as data 121 any suitable attention probabilities A_i from transformer layers (e.g., layers component 112) of transformer model module 120 and/or any suitable vocabulary size V for normalization. Uncertainty component 100 may be configured to carry out any suitable processing, including, but not limited to, Shannon entropy for each token position j (e.g., U(i)=−SUM_j p(a_ij)×log2(p(a_ij)) (e.g., Uncertainty(U)=−Σp(a)×log(p(a)), where p(a) may represent the attention probability distribution over tokens within the memory unit); normalized to [0,1]), range of probabilities across the vocabulary (e.g., U_norm(i)=U(i)/log2(V), where higher values may indicate more distributed (uncertain) attention patterns), and/or the like. Therefore, uncertainty component 100 may be configured to receive attention distributions from transformer attention layers (e.g., as data 121) and output any suitable data 131, which may be indicative of any suitable information, including, but not limited to, a normalized uncertainty score (e.g., U_norm in [0,1]) for each token position. A_1 may refer to layer 1, A_i may refer to position i. In entropy formulas, i may refer to query position, and j may refer to key/value positions. In some embodiments, t may refer to position/time step in sequential processing. This may apply to any sequential system regardless of unit type (e.g., tokens, time steps, state snapshots, etc.).

Novelty component 101 may be configured to carry out any suitable multi-scale layer-specific surprise aggregation capturing information content at different abstraction levels (e.g., aggregate information content from early, middle, and late transformer layers (e.g., layers of component 112)). For example, novelty component 101 may be configured to receive as data 122 any suitable hidden states from any suitable layers (e.g., early layers (e.g., layers 1-8), middle layers (e.g., layers 9-16), and late layers (e.g., layers 17-24)) and/or any suitable trainable weights w (e.g., weights w={0.2, 0.5, 0.3}). Novelty component 101 may be configured to carry out any suitable processing, such as aggregate a novelty score for each token position (e.g., for each layer 1, determine IC_1(t)=−log2(P_1(t)), and aggregate Novelty(t)=SUM_1 w_1×IC_1(t)), where default weights may emphasize middle layers where semantic content emerges). Therefore, novelty component 101 may be configured to receive layer hidden states (e.g., as data 122) and output any suitable data 132, which may be indicative of any suitable information, including, but not limited to, an aggregated novelty score for each token position. Such multi-layer aggregation may be configured to capture information surprise at different abstraction levels, as opposed to other techniques that may use only sequence-level (e.g., Kullback-Leibler (“KL”)) divergence, which may miss layer-specific patterns.

Coherence component 102 may be configured to graph-theoretic coherence (e.g., via Fiedler vector analysis), such as to construct a k-nearest-neighbor (“k-nn”) graph over token embeddings to model local semantic relationships. For example, coherence component 102 may be configured to receive as data 123 any suitable token embeddings E (e.g., E={e1, e2, . . . , en}) with any suitable neighborhood size k (e.g., k=8) and/or any suitable window win (e.g., win=16 for local variance), such as for receiving token embeddings for a k-NN graph.

It is to be understood that budget k and neighborhood k are different parameters that may share a letter representation by convention. Neighborhood k may be a graph construction parameter, while budget k may be a total resource allocation. A score s may be a combined importance score via aggregation (e.g., mean, max, weighted). Layer weights and combination weights may operate at different stages. All values herein may be illustrative, while all weights may be configurable/trainable. Coherence component 102 may be configured to carry out any suitable processing, including, but not limited to, build a k-NN graph with cosine similarity, compute Laplacian (e.g., L_norm=I−D\hat{ }(−1/2)×A×D\hat{ }(−1/2)), extract Fiedler vector v2 via eigendecomposition, determine coherence (e.g., C(i)=1/(1+Var_local(v2))), and/or the like. Therefore, coherence component 102 may be configured to receive embeddings from transformer model module 120 (e.g., as data 123) and output any suitable data 133, which may be indicative of any suitable information, including, but not limited to, a determined coherence C(i) in [0,1] for each token, and/or output any suitable data 135, which may be indicative of any suitable information, including, but not limited to, Fiedler zero-crossings marking semantic boundaries, and/or the like. Such O(n log n) complexity (e.g., for processing a sequence of n tokens) via k-nearest-neighbor graph construction may be distinct from and provide benefits over other techniques that may use O(n\hat{ }2) transformer self-attention. While O(1) may be a constant time (e.g., EMA update). For 100,000 elements, computational complexity O(n log n) may be ~1.7M while computational complexity O(n²) may be ~10B. Such benefits may be scalability, sub-quadratic memory, real-time processing, edge deployment, cost efficiency, and/or the like. This may be achieved via sparse graph, approximate nearest neighbor, any sub-quadratic algorithm, and/or the like.

UNC combiner 103 may be configured to fuse uncertainty, novelty, and coherence scores into unified attention weight using configurable combination weights. For example, UNC combiner 103 may be configured to receive any suitable uncertainty scores U as data 131 from uncertainty component 100, any suitable novelty scores N as data 132 from novelty component 101, any suitable coherence scores C as data 133 from coherence component 102, any suitable weights (e.g., weights alpha (e.g., w_early)=0.3, beta (e.g., w_mid)=0.4, gamma (e.g., w_late)=0.3), and/or the like. UNC combiner 103 may be configured to carry out any suitable processing, such as linear combination (e.g., UNC(t)=alpha×U(t)+beta×N(t)+gamma×C(t), where Constraint: alpha+beta+gamma=1.0, with any suitable optional trainable weight optimization via backpropagation). Therefore, UNC combiner 103 may be configured to receive U, N, and C scores for each token from components 100-102 (e.g., as data 131-133) and output any suitable data 134, which may be indicative of any suitable information, such as combined UNC scores for each token. This three-component fusion that may combine entropy-based uncertainty, multi-layer novelty, and graph-theoretic coherence for attention weighting is unique and provides many benefits over other solutions. There may be various benefits of combining multiple distinct importance signals, including, but not limited to, robustness (e.g., different signals capture complementary aspects, whereby combination may be more robust than single signal), adaptability (e.g., trainable weights may optimize for domains without architecture changes), multi-scale awareness (e.g., signals may operate at different abstraction levels), boundary precision (e.g., multi-criterion detection improves segmentation quality), interpretability (e.g., components may be inspectable independently), extensibility (e.g., additional signals addable), and/or the like (e.g., encompasses any two or more distinct complementary signals).

Memory management module 140 may include any suitable components or modules, including, but not limited to, any suitable adaptive threshold component or module 104 that may receive any suitable data 134 from UNC attention engine 130 and/or that may provide any suitable data 104a, any suitable boundary detector or boundary detector component or boundary detector module 105 that may receive any suitable data 134 from UNC attention engine 130 and/or data 104a from module 104 and/or data 135 from module 102 and/or that may provide any suitable data 105a, any suitable resource allocator component or module 106 that may receive any suitable data 134 from UNC attention engine 130 and/or data 105a from module 105 and/or that may provide any suitable data 141, 142, and 143. Memory management module 140 may be configured to handle adaptive thresholding, boundary detection, and/or resource allocation. Memory management module 140 may be configured to determine how token sequences may be segmented into memory units and/or how resources may be distributed across priority tiers. For example, memory management module 140 may be configured to receive any suitable input data, including, but not limited to, any suitable UNC score(s) from UNC attention engine 130, any suitable Fiedler zero-crossings, any suitable system resource budget k, any suitable configuration parameters (e.g., lambda (“λ”), rho (“ρ”), thresholds, etc.), and/or the like. Memory management module 140 may be configured to carry out any suitable processing, including, but not limited to, any suitable exponential moving average (“EMA”) threshold adaptation (e.g., threshold adaptation: threshold theta(t)=lambda×UNC(t)+(1−lambda)×theta(t−1)), any suitable dual-criterion boundary detection, any suitable power-law resource allocation (e.g., power-law resource allocation: A(s)=k×(1/s\hat{ }ρ)), and/or the like. Therefore, memory management module 140 may be configured to receive any suitable input data (e.g., score(s), zero-crossings, resource budget, configuration parameters, etc.) and output any suitable data (e.g., data 141-143 for hierarchical memory module 150), which may be indicative of any suitable information, including, but not limited to, any suitable segmented memory units with boundaries, any suitable tier assignments (e.g., HIGH/MEDIUM/LOW), any suitable resource allocations per unit, and/or the like.

Adaptive threshold component 104 may be configured to adapt a threshold (e.g., an exponential moving average (“EMA”) threshold) to local content statistics for boundary detection. For example, threshold component 104 may be configured to receive as data 134 any suitable UNC scores and/or any suitable EMA smoothing parameter lambda. Threshold component 104 may be configured to carry out any suitable processing, including, but not limited to, EMA update (e.g., theta(t)=lambda×UNC(t)+(1−lambda)×theta(t−1)) and provide O(1) per-token update (e.g., with any suitable configurable memory horizon (e.g., a configurable memory horizon of approximately 1/lambda tokens)). Therefore, threshold component 104 may be configured to receive UNC scores and EMA smoothing parameter lambda and output any suitable data 104a, which may be indicative of any suitable information, including, but not limited to, an adaptive threshold theta(t) for boundary decision.

Boundary detector component 105 may be configured to achieve dual-criterion boundary detection (e.g., by combining any suitable statistical and structural methods). For example, boundary detector component 105 may be configured to receive any suitable UNC scores as data 134 from UNC combiner 103 of UNC attention engine 130, adaptive threshold theta(t) as data 104a from threshold component 104, and Fiedler zero-crossings as data 135 from coherence component 102 of UNC attention engine 130. Boundary detector component 105 may be configured to carry out any suitable processing, including, but not limited to, marking a boundary where UNC(t)>theta(t) AND near Fiedler zero-crossing, enforcing any suitable minimum and maximum token constraints (e.g., min=32, max=512), merging UNC-based and Fiedler-based boundaries, and/or the like. Therefore, boundary detector component 105 may be configured to receive UNC scores and adaptive threshold theta(t) and Fiedler zero-crossings and output any suitable data 105a, which may be indicative of any suitable information, including, but not limited to, boundary positions B (e.g., B={b1, b2, . . . , bm}) that may be defining memory unit partitions. In some embodiments, for post-processing, minimum enforcement may merge small segments, and/or maximum enforcement may insert boundaries at local maxima. Multi-criterion detection may be achieved via intersection, union, learned fusion, or cascading. For continuous-state architectures, boundaries may correspond to state transitions, gate thresholds, or time windows rather than hard token boundaries.

Resource allocator component 106 may be configured to power-law resource allocation with configurable distribution exponent. For example, resource allocator component 106 may be configured to receive any suitable UNC scores as data 134 from UNC combiner 103 of UNC attention engine 130 and boundary positions B as data 105a from boundary detector component 105, so as to access memory units with UNC scores, a total budget k, and an exponent rho in [0.5, 2.0]. Resource allocator component 106 may be configured to carry out any suitable processing, including, but not limited to, any suitable power-law formula (e.g., A(s)=k×(1/s\hat{ }rho), where s may be the memory unit UNC score), any suitable tier assignment (e.g., HIGH if s>0.7, MEDIUM if s>0.3, else LOW (DORMANT)), any suitable normalizing (e.g., normalize to respect budget constraint), and/or the like. Therefore, resource allocator component 106 may be configured to receive memory units with UNC scores, total budget k, and exponent rho and output any suitable data 141-143, which may be indicative of any suitable information, including, but not limited to, tier assignments and resource allocations for each memory unit (e.g., data 141 may be high-priority units (e.g., UNC>0.7), data 142 may be medium-priority units (e.g., 0.3<UNC<=0.7), data 143 may be low-priority units (e.g., UNC<=0.3), etc.). Exponent rho may be tunable in any suitable way(s) to enable any suitable domain-specific optimization (e.g., technical documents may use rho=1.5, narrative text may use rho=0.8, etc.). For example, exponent rho may control allocation sensitivity, where rho=1.0 may provide a linear inverse relationship (e.g., balanced allocation), rho<1.0 may provide a gentler curve (e.g., more resources to low-UNC units), and rho>1.0 may provide a steeper curve (e.g., aggressive prioritization of high-UNC).

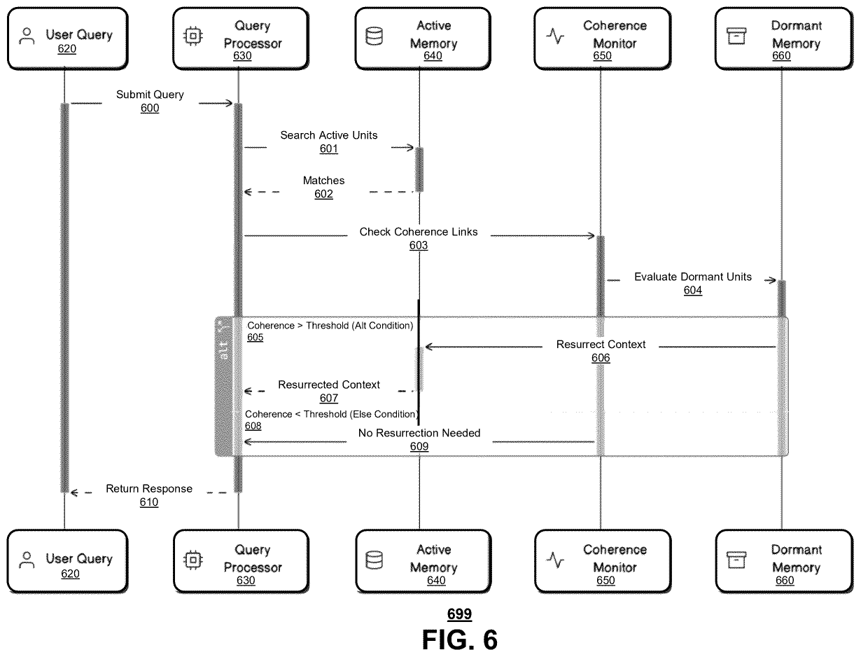

Hierarchical memory module 150 may include any suitable components or modules, including, but not limited to, any suitable high-priority units or high-fidelity tier module 107 that may receive any suitable data 141 from resource allocator component 106 and generate any suitable data 151, any suitable medium-priority units or medium-fidelity tier module 108 that may receive any suitable data 142 from resource allocator component 106 and generate any suitable data 152, and any suitable dormant or low-priority units or low-fidelity tier module 109 that may receive any suitable data 143 from resource allocator component 106 and generate any suitable data 153, and any suitable coherence links or coherent link manager module 110 that may receive data 151-153 and generate any suitable data 110a. Hierarchical memory module 150 may be configured to implement the three-tier storage architecture with coherence-based linking. Hierarchical memory module 150 may be configured to store memory units at appropriate fidelity levels and maintain the bidirectional coherence graph that may enable context resurrection. For example, hierarchical memory module 150 may be configured to receive any suitable input data, including, but not limited to, any suitable memory units with tier assignments (e.g., from memory management module 140), any suitable coherence scores for link creation (e.g., from coherence component 102), any suitable query embeddings for retrieval, and/or the like. Hierarchical memory module 150 may be configured to carry out any suitable processing, including, but not limited to, any suitable tier-appropriate storage (e.g., float32/float16/summary), any suitable coherence link maintenance, any suitable resurrection trigger evaluation, any suitable decompression when needed, and/or the like. Therefore, hierarchical memory module 150 may be configured to receive any suitable input data (e.g., memory units with tier assignments, coherence sores, embeddings for retrieval, etc.) and output any suitable data (e.g., data 110a), which may be indicative of any suitable information, including, but not limited to, any suitable retrieved memory units for query processing, any suitable resurrected context from dormant storage, any suitable updated coherence graph, and/or the like. Any suitable output of hierarchical memory module 150 may be configured to interface with any suitable query processing (see, e.g., process 699 of FIG. 6).

High-fidelity tier module 107 may be configured to provide full-fidelity storage for high-priority memory units. For example, high-fidelity tier module 107 may be configured to receive high-priority units as data 141. High-fidelity tier module 107 may be configured to carry out any suitable processing, including, but not limited to, float32 storage, complete attention cache retained, no compression applied, serve as coherence link anchor, and/or the like. Therefore, high-fidelity tier module 107 may be configured to receive high-priority units and output any suitable data 151, which may be indicative of any suitable information, including, but not limited to, full-fidelity memory units ready for direct retrieval.

Medium-fidelity tier module 108 may be configured to provide medium-fidelity storage for medium-priority memory units (e.g., compressed storage with 2-4× compression ratio). For example, medium-fidelity tier module 108 may be configured to receive medium-priority units as data 142. Medium-fidelity tier module 108 may be configured to carry out any suitable processing, including, but not limited to, float16/int8 quantization, partial attention cache retained, maintain bidirectional coherence links, and/or the like. Therefore, medium-fidelity tier module 108 may be configured to receive medium-priority units and output any suitable data 152, which may be indicative of any suitable information, including, but not limited to, compressed memory units with coherence link references.

Low-fidelity tier module 109 may be configured to provide low-fidelity storage for low-priority memory units (e.g., minimal storage with resurrection capability via coherence links). For example, low-fidelity tier module 109 may be configured to receive low-priority units as data 143. Low-fidelity tier module 109 may be configured to carry out any suitable processing, including, but not limited to, 10-50× compression, summary vectors only, centroid embedding, coherence links preserved for potential resurrection, and/or the like. Therefore, low-fidelity tier module 109 may be configured to receive low-priority units and output any suitable data 153, which may be indicative of any suitable information, including, but not limited to, dormant memory units with resurrection potential. Such dormant units can resurrect via coherence links when related high-priority content is accessed, unlike other solutions that may discard low-priority content.

Coherent link manager module 110 may be configured to manage bidirectional coherence links across all memory tiers. For example, coherent link manager module 110 may be configured to receive any suitable data from the memory tiers as data 151-153. As shown, data flow between coherent link manager module 110 and memory tiers as data 151-153 may be bidirectional, as units may flow to relationship creation, and retrieval may traverse back. Coherent link manager module 110 may be configured to carry out any suitable processing, including, but not limited to, create links (e.g., links: {source, target, strength, relation}), create relations (e.g., relations: causal, temporal, referential, thematic), enable cross-tier resurrection triggers, and/or the like. Therefore, coherent link manager module 110 may be configured to connect the memory tiers and output any suitable data 110a, which may be indicative of any suitable information, including, but not limited to, any suitable coherence link graph(s) connecting all memory tiers. Such an explicit coherence graph with quantified semantic relationships is unique and provides many benefits over other solutions. Consumers may be any suitable query processors, inference, RAG pipelines, external apps, monitoring, training, and/or the like. Benefits achieved may include, but are not limited to, selective retrieval, efficient lookup, cross-tier connectivity, typed relationships for routing, graceful degradation, composability with external knowledge, and/or the like.

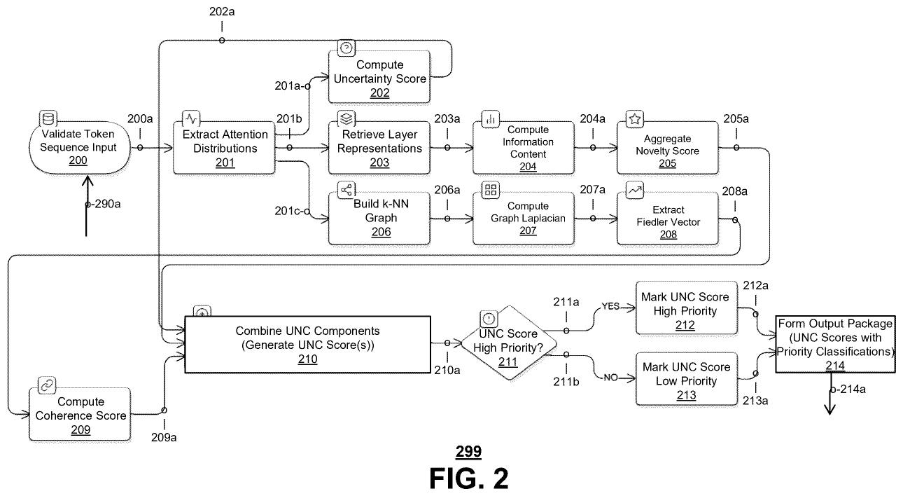

### FIG. 2

FIG. 2 is a flowchart of an illustrative process 299 for computing any suitable uncertainty, novelty, and/or coherence scores and/or any combination thereof. At operation 200 of process 299, a system (e.g., system 199 of FIG. 1B or otherwise) may validate a token sequence input. For example, operation 200 may be an entry point for a UNC computation pipeline that may be receiving a tokenized input sequence with attention distributions. Operation 200 may be configured to work on any suitable input(s) (e.g., data 290a, etc.), including, but not limited to, any suitable tokenized input sequence (e.g., tokenized input sequence T={t1, t2, . . . , tn}), any suitable attention probability distributions (e.g., attention probability distributions A={A1, A2, . . . , An}, where each Ai may represent attention weights over a vocabulary V), and/or the like from any suitable source(s) (e.g., from any suitable transformer attention layers (e.g., layer component 111 of FIG. 1B) or otherwise). Operation 200 may be configured to carry out any suitable processing, including, but not limited to, validating any suitable input sequence length constraints (e.g., min: 1 token, max: context_length, etc.), initializing any suitable computation buffers, triggering simultaneous dispatch to three parallel computation branches, and/or the like. Therefore, operation 200 may be configured to operate on any suitable data (e.g., a tokenized input sequence, attention probability distributions, etc.) and output any suitable data 200a, which may be indicative of any suitable information, including, but not limited to, a validated token sequence, attention distributions, and/or the like, which may be utilized by any further operations.

At operation 201 of process 299, the system may extract attention distributions. For example, operation 201 may extract and normalize attention probability distributions from transformer layers (e.g., from data 200a) for downstream UNC component calculations. Operation 201 may be configured to work on any suitable input(s) (e.g., data 200a, etc.), including, but not limited to, any suitable raw attention logits from any suitable transformer layers, any suitable layer indices that may specify which layers to extract (e.g., configurable: early, middle, late), and/or the like. Operation 201 may be configured to carry out any suitable processing, including, but not limited to, applying any suitable normalization (e.g., softmax normalization) to raw attention logits, extracting attention distributions from specified layers, formatting attention tensors for parallel processing, and/or the like. Therefore, operation 201 may be configured to operate on any suitable data (e.g., raw attention logits, layer indices that may specify which layers to extract, etc.) and output any suitable data 201a-201c, which may be indicative of any suitable information, including, but not limited to, any suitable normalized attention distributions (e.g., normalized attention distributions A_norm with shape [batch_size, num_heads, seq_len, seq_len]), any suitable layer-specific attention maps, and/or the like, which may be utilized by any further operations. Therefore, operation 201 may be configured to branch to various parallel paths (e.g., uncertainty, novelty, and coherence paths). Such a branching point may enable parallel computation of all three UNC components, thereby reducing latency compared to possible sequential approaches.

At operation 202 of process 299, the system may compute uncertainty score. For example, operation 202 may calculate any suitable entropy-based uncertainty score that may measure the dispersion of attention probabilities. Operation 202 may be configured to work on any suitable input(s) (e.g., data 201a, etc.), including, but not limited to, any suitable normalized attention distribution (e.g., normalized attention distribution Ai for token position i), any suitable entropy normalization constant log2(V), and/or the like. Operation 202 may be configured to carry out any suitable processing, including, but not limited to, Shannon entropy (e.g., entropy: U(i)=−SUM_j p(aij)×log2(p(aij))), normalization (e.g., normalization to [0,1]: U_norm(i)=U(i)/log2(V), where higher values may be more distributed (uncertain) attention, and/or the like. Therefore, operation 202 may be configured to operate on any suitable data (e.g., normalized attention distribution, etc.) and output any suitable data 202a, which may be indicative of any suitable information, including, but not limited to, any suitable normalized uncertainty score (e.g., normalized uncertainty score U_norm in [0,1] for each token), any suitable uncertainty vector (e.g., uncertainty vector U={U1, U2, . . . , Un}), and/or the like, which may be utilized by any further operations. Therefore, operation 202 may be configured to receive attention distributions and provide one or more outputs for combination. Such use of normalized Shannon entropy rather than raw entropy may be unique and/or may enable cross-sequence comparability regardless of vocabulary size.

At operation 203 of process 299, the system may retrieve or otherwise get layer representations. For example, operation 203 may retrieve hidden state representations from multiple transformer layers for multi-scale novelty computation. Operation 203 may be configured to work on any suitable input(s) (e.g., data 201b, etc.), including, but not limited to, any suitable layer indices (e.g., layer indices L={1_early, 1_mid, 1_late} (e.g., with any suitable default, such as default: layers 4, 16, 28 for 32-layer model)), any suitable model hidden states (e.g., model hidden states H from each layer), and/or the like. Operation 203 may be configured to carry out any suitable processing, including, but not limited to, extracting hidden representations (e.g., hidden representations h_1 for each specified layer), applying layer normalization for scale consistency, caching representations for information content computation, and/or the like. Therefore, operation 203 may be configured to operate on any suitable data (e.g., layer indices, model hidden states, etc.) and output any suitable data 203a, which may be indicative of any suitable information, including, but not limited to, any suitable layer-specific hidden states (e.g., layer-specific hidden states: {h_early, h_mid, h_late} with shape [batch_size, seq_len, hidden_dim]), and/or the like, which may be utilized by any further operations. Therefore, operation 203 may be configured to receive layer specifications and provide one or more outputs for further processing of an N score.

At operation 204 of process 299, the system may compute information content. For example, operation 204 may calculate information content (e.g., self-information) at each layer using learned probability estimates. Operation 204 may be configured to work on any suitable input(s) (e.g., data 203a, etc.), including, but not limited to, any suitable any suitable layer-specific hidden states (e.g., from operation 203), any suitable learned probability estimator networks (e.g., learned probability estimator networks P_1 for each layer), and/or the like. Operation 204 may be configured to carry out any suitable processing, including, but not limited to, for each layer 1, estimating token probability (e.g., token probability p_1(ti) using layer-specific MLP (e.g., multilayer perceptron)), computing information content (e.g., information content IC_1(ti)=−log2(max(p_1(ti), epsilon)) with epsilon=1e−10 for numerical stability), and/or the like. Therefore, operation 204 may be configured to operate on any suitable data (e.g., layer-specific hidden states, learned probability estimator networks, etc.) and output any suitable data 204a, which may be indicative of any suitable information, including, but not limited to, any suitable information content values (e.g., information content values IC_1(ti) for each token at each layer), and/or the like, which may be utilized by any further operations. Therefore, operation 204 may be configured to further the N score calculation.

At operation 205 of process 299, the system may aggregate novelty score. For example, operation 205 may combine layer-specific information content into a single novelty score using learned or fixed layer weights. Operation 205 may be configured to work on any suitable input(s) (e.g., data 204a, etc.), including, but not limited to, any suitable information content values from operation 204, any suitable layer weights (e.g., layer weights w={w_early, w_mid, w_late} (e.g., any suitable default (e.g., default: 0.2, 0.5, 0.3))), and/or the like. Operation 205 may be configured to carry out any suitable processing, including, but not limited to, any suitable weighted aggregation (e.g., weighted aggregation: Novelty(ti)=SUM_1 w_1×IC_1(ti)), any suitable (e.g., optional) trainable weight learning, any suitable normalization to standard scale, and/or the like. Therefore, operation 205 may be configured to operate on any suitable data (e.g., information content values, layer weights, etc.) and output any suitable data 205a, which may be indicative of any suitable information, including, but not limited to, any suitable aggregated novelty score (e.g., aggregated novelty score: Novelty(ti) for each token), and/or the like, which may be utilized by any further operations. Therefore, multi-scale layer-specific novelty aggregation may capture information surprise at different abstraction levels. Default weights (e.g., 0.2, 0.5, 0.3) may emphasize middle layers where semantic content may emerge.

At operation 206 of process 299, the system may build a k-NN graph. For example, operation 206 may construct a k-nearest-neighbor similarity graph over token embeddings to model local semantic relationships. Operation 206 may be configured to work on any suitable input(s) (e.g., data 201c, etc.), including, but not limited to, any suitable token embeddings (e.g., token embeddings E={e1, e2, . . . , en}, where ei is in R\hat{ }d), any suitable neighborhood size (e.g., neighborhood size k (e.g., default: k=8)), and/or the like. Operation 206 may be configured to carry out any suitable processing, including, but not limited to, computing pairwise cosine similarity (e.g., cosine similarity: sim(ei, ej)=(ei.ej)/(∥ei∥×∥ej∥)), identifying k nearest neighbors per token, constructing sparse adjacency (e.g., adjacency A_knn), any suitable symmetrizing (e.g., symmetrization A_sym=(A_knn+A_knn\hat{ }T)/2), and/or the like. Therefore, operation 206 may be configured to operate on any suitable data (e.g., token embeddings, neighborhood size, etc.) and output any suitable data 206a, which may be indicative of any suitable information, including, but not limited to, any suitable symmetric k-NN adjacency matrix (e.g., symmetric k-NN adjacency matrix A_sym), any suitable edge weights representing semantic similarity, and/or the like, which may be utilized by any further operations. Therefore, such k-NN graph construction may enable O(n log n) computational complexity, as compared to O(n\hat{ }2) full attention.

At operation 207 of process 299, the system may compute graph Laplacian. For example, operation 207 may compute a normalized graph Laplacian matrix for spectral analysis of token relationships. Operation 207 may be configured to work on any suitable input(s) (e.g., data 206a, etc.), including, but not limited to, any suitable symmetric adjacency matrix A_sym (e.g., from operation 206), any suitable degree matrix computation, and/or the like. Operation 207 may be configured to carry out any suitable processing, including, but not limited to, computing degree matrix (e.g., degree matrix: D_ii=SUM_j A_sym[i,j]), computing normalized Laplacian (e.g., normalized Laplacian: L_norm=I−D\hat{ }(−1/2)×A_sym×D\hat{ }(−1/2)), handling degree-zero nodes with epsilon smoothing, and/or the like. Therefore, operation 207 may be configured to operate on any suitable data (e.g., symmetric adjacency matrix A_sym, degree matrix computation, etc.) and output any suitable data 207a, which may be indicative of any suitable information, including, but not limited to, any suitable normalized Laplacian matrix (e.g., normalized Laplacian matrix L_norm), and/or the like, which may be utilized by any further operations.

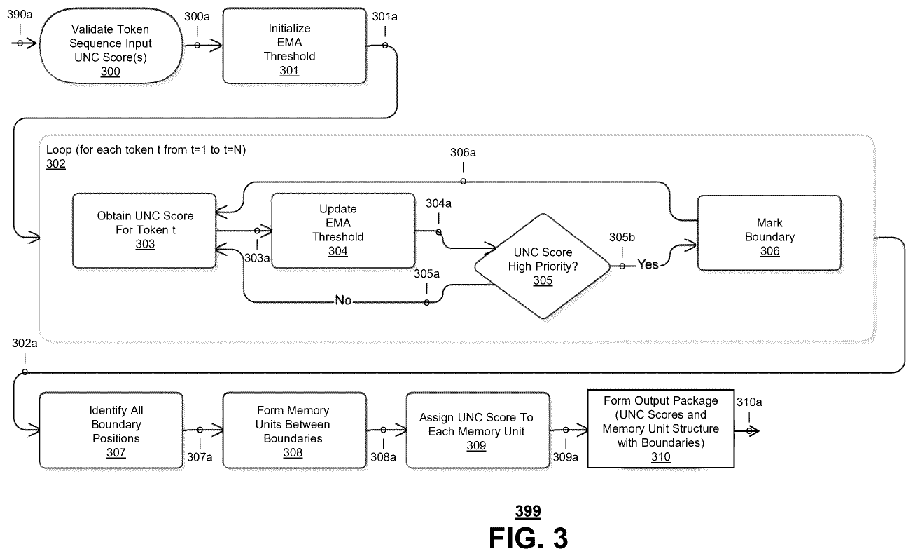

At operation 208 of process 299, the system may extract Fiedler vector. For example, operation 208 may compute the Fiedler vector (e.g., a second-smallest eigenvector of the Laplacian) to identify natural segmentation points. Operation 208 may be configured to work on any suitable input(s) (e.g., data 207a, etc.), including, but not limited to, any suitable normalized Laplacian L_norm (e.g., from operation 207), any suitable eigenvector computation parameters, and/or the like. Operation 208 may be configured to carry out any suitable processing, including, but not limited to, conducting any suitable eigendecomposition of L_norm, extracting second-smallest eigenvalue (e.g., Fiedler value lambda_2) and eigenvector (e.g., Fiedler vector v2), processing any zero-crossings in v2 to indicate natural partition boundaries, and/or the like. Therefore, operation 208 may be configured to operate on any suitable data (e.g., normalized Laplacian L_norm, computation parameters, etc.) and output any suitable data 208a, which may be indicative of any suitable information, including, but not limited to, any suitable Fiedler vector v2, any suitable Fiedler value lambda_2 (e.g., an algebraic connectivity measure), and/or the like, which may be utilized by any further operations. Therefore, operation 208 may be configured to be critical for boundary detection, where zero-crossings in Fiedler vector may provide graph-theoretic boundary candidates that may be used with UNC thresholding (see, e.g., process 399 of FIG. 3).

At operation 209 of process 299, the system may compute coherence score. For example, operation 209 may derives coherence scores from Fiedler vector values, measuring each token's connectivity within its local semantic neighborhood. Operation 209 may be configured to work on any suitable input(s) (e.g., data 208a, etc.), including, but not limited to, any suitable Fiedler vector v2 (e.g., from operation 208), local window size win for variance computation (e.g., any suitable default (e.g., default: win=16)), and/or the like. Operation 209 may be configured to carry out any suitable processing, including, but not limited to, extracting local Fiedler values in window [i−win/2, i+win/2], computing local variance; computing coherence (e.g., coherence: C(i)=1/(1+Var_local(i)), where high coherence=well-connected, low coherence=potential boundary, etc.), for each position i, and/or the like. Therefore, operation 209 may be configured to operate on any suitable data (e.g., Fiedler vector v2, local window size, etc.) and output any suitable data 209a, which may be indicative of any suitable information, including, but not limited to, any suitable coherence score (e.g., coherence score C(i) in [0,1]) for each token position, any suitable coherence vector (e.g., coherence vector C={C1, C2, . . . , Cn}), and/or the like, which may be utilized by any further operations.

At operation 210 of process 299, the system may combine UNC components. For example, operation 210 may fuses uncertainty, novelty, and coherence scores into unified UNC attention weight. Operation 210 may be configured to work on any suitable input(s) (e.g., data 202a, 205a, 209a, etc.), including, but not limited to, any suitable uncertainty score(s) U (e.g., from operation 202), any suitable novelty score(s) N (e.g., from operation 205), any suitable coherence score(s) C (e.g., from operation 209), any suitable weights (e.g., weights alpha=0.3, beta=0.4, gamma=0.3), and/or the like. Operation 210 may be configured to carry out any suitable processing, including, but not limited to, any suitable linear combination (e.g., linear combination: UNC(ti)=alpha×U(ti)+beta×N(ti)+gamma×C(ti), where any suitable constraints alpha+beta+gamma=1.0), utilizing any suitable (e.g., optional) trainable weight optimization, and/or the like. Therefore, operation 210 may be configured to operate on any suitable data (e.g., UNC scores, weights, etc.) and output any suitable data 210a, which may be indicative of any suitable information, including, but not limited to, any suitable combined UNC score for each token (e.g., UNC={UNC1, UNC2, . . . , UNCn}), and/or the like, which may be utilized by any further operations (e.g., to feed threshold check and/or memory allocation). Therefore, operation 210 may be configured to combine entropy-based uncertainty, multi-layer novelty, and graph-theoretic coherence for attention weighting, which may provide many benefits over other solutions.

At operation 211 of process 299, the system may determine a priority of each token's UNC score. Operation 211 may be configured to work on any suitable input(s) (e.g., data 210a, etc.), including, but not limited to, any suitable combined UNC score for each token (e.g., from operation 210), any suitable EMA smoothing parameter lambda, and/or the like. Operation 211 may be configured to carry out any suitable processing, including, but not limited to, determining if, for a particular token t, UNC(t)>adaptive threshold theta(t), where theta(t)=lambda×UNC(t)+(1−lambda)×theta(t−1), and if so, advancing to operation 212, and if not, advancing to operation 213. Therefore, operation 211 may be configured to operate on any suitable data (e.g., UNC score for each token, EMA smoothing parameter lambda, etc.) to determine whether or not UNC(t) is greater than adaptive threshold theta(t), and providing any suitable data 211a (e.g., UNC(t)) to operation 212 when UNC(t) is greater than adaptive threshold theta(t), and providing any suitable data 211b (e.g., UNC(t)) to operation 213 when UNC(t) is not greater than adaptive threshold theta(t). Any suitable number of priorities may be used (e.g., more than two) depending on the architecture chosen.

At operation 212 of process 299, the system may mark a particular UNC score for a particular token t (e.g., UNC(t)) as high priority. Operation 212 may be configured to work on any suitable input(s) (e.g., data 211a, etc.), including, but not limited to, any suitable UNC(t) determined to be greater than theta(t) (e.g., from operation 211), and/or the like. Operation 212 may be configured to carry out any suitable processing, including, but not limited to, marking that UNC(t) as high priority (e.g., marking that UNC(t) with a high priority classification) and then providing such a high priority marked UNC score (e.g., UNC(t)) as data 212a to operation 214.

At operation 213 of process 299, the system may mark a particular UNC score for a particular token t (e.g., UNC(t)) as low priority. Operation 213 may be configured to work on any suitable input(s) (e.g., data 211b, etc.), including, but not limited to, any suitable UNC(t) determined not to be greater than theta(t) (e.g., from operation 211), and/or the like. Operation 213 may be configured to carry out any suitable processing, including, but not limited to, marking that UNC(t) as low priority (e.g., marking that UNC(t) with a low priority classification) and then providing such a low priority marked UNC score (e.g., UNC(t)) as data 213a to operation 214.

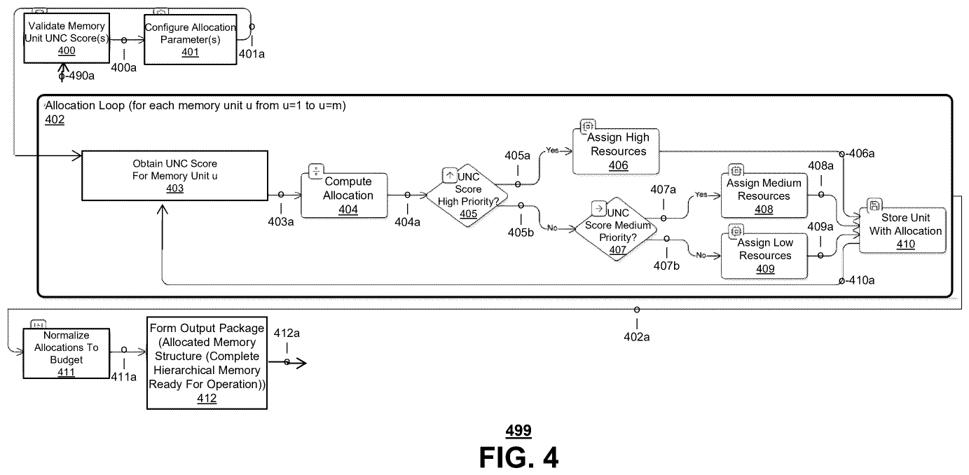

At operation 214 of process 299, the system may form an output package. Operation 213 may be configured to work on any suitable input(s) (e.g., data 212a, 213a, etc.), including, but not limited to, any suitable low priority marked UNC score(s), any suitable high priority marked UNC score(s), and/or the like. Operation 214 may be configured to carry out any suitable processing, including, but not limited to, packaging any such score(s) into any suitable output package as data 214a, which may be utilized by any further operations. Therefore, operations 211-214 may be configured to package any suitable UNC score(s) with priority classifications (e.g., for any suitable boundary detection (e.g., of process 399 of FIG. 3), for any suitable resource allocation (e.g., of process 499 of FIG. 4), etc.).

It is understood that the operations shown in process 299 of FIG. 2 are only illustrative and that existing operations may be modified or omitted, additional operations may be added, and the order of certain operations may be altered.

### FIG. 3

FIG. 3 is a flowchart of an illustrative process 399 for detecting memory unit boundaries (e.g., using adaptive EMA thresholding). For example, process 399 may segment a continuous token stream into discrete memory units based on UNC score transitions.

At operation 300 of process 399, a system (e.g., system 199 of FIG. 1B or otherwise) may validate a token sequence input has UNC scores. For example, operation 300 may be an entry point for boundary detection that may be receiving a token sequence with precomputed UNC scores. Operation 300 may be configured to work on any suitable input(s) (e.g., data 390a, etc.), including, but not limited to, any suitable token sequence (e.g., token sequence T={t1, t2, . . . , tn}) with any suitable UNC scores (e.g., UNC scores UNC={UNC1, UNC2, . . . , UNCn} (e.g., data 210a from process 299 of FIG. 2)), and/or the like. Operation 300 may be configured to carry out any suitable processing, including, but not limited to, validating the input sequence has associated UNC scores, initializing any suitable boundary detection state machine, preparing any suitable iteration, and/or the like. Therefore, operation 300 may be configured to operate on any suitable data (e.g., token sequence with UNC scores, etc.) and output any suitable data 300a, which may be indicative of any suitable information, including, but not limited to, any suitable validated input that may be ready for EMA threshold initialization, and/or the like, which may be utilized by any further operations.

At operation 301 of process 399, the system may initialize an EMA threshold. For example, operation 301 may set an initial adaptive threshold value (e.g., using an exponential moving average initialization strategy). Operation 301 may be configured to work on any suitable input(s) (e.g., data 301a, etc.), including, but not limited to, any suitable UNC scores for a window of tokens, any suitable initial threshold configuration, and/or the like. Operation 301 may be configured to carry out any suitable processing, including, but not limited to, computing an initial adaptive threshold (e.g., threshold: theta(0)=(1/win)×SUM UNC(ti) for i=1 to win, where win=32 (or fixed 0.5) or any other suitable window size), setting any suitable EMA smoothing lambda (e.g., EMA smoothing lambda=0.1 (e.g., lambda may be between 0.05 and 0.2)), and/or the like. Therefore, operation 301 may be configured to operate on any suitable data (e.g., UNC scores for a window of tokens, initial threshold configuration, etc.) and output any suitable data 301a, which may be indicative of any suitable information, including, but not limited to, any suitable an initialized threshold theta(0), any suitable EMA parameter lambda, and/or the like, which may be utilized by any further operations. Therefore, operation 301 may be configured to be adaptive, such that, unlike fixed thresholds, EMA may adapt to local content statistics, improving boundary detection across diverse content types.

At a loop 302, one or more iterations of one or more operations 303, 304, 305, and/or 306 may be carried out between operation 301 and operation 307 of process 399 (e.g., for each token t from t=1 to t=N). At operation 303 of process 399, the system may obtain UNC score for token t. For example, operation 303 may retrieve UNC(t) (e.g., UNC(t)=cached_UNC[t]) or operation 303 may trigger real-time computation. Operation 303 may be configured to work on any suitable input(s) (e.g., data 301a, etc.), including, but not limited to, any suitable UNC(t) score, and/or the like. Operation 303 may be configured to carry out any suitable processing, including, but not limited to, obtaining a UNC score UNC(t) for a particular one of token t=1 to token t=N of the current loop iteration and providing that UNC score UNC(t) as output data 303a, which may be utilized by any further operations (e.g., operation 304).

At operation 304 of process 399, the system may update the EMA threshold. For example, operation 304 may update the adaptive threshold using any suitable exponential moving average formula. Operation 304 may be configured to work on any suitable input(s) (e.g., data 303a, etc.), including, but not limited to, any suitable current UNC score UNC(t) (e.g., from operation 303 of the current iteration of loop 302), a previous threshold (e.g., previous threshold theta(t−1)), any suitable EMA parameter lambda, and/or the like. Operation 304 may be configured to carry out any suitable processing, including, but not limited to, EMA updating (e.g., updating the threshold: theta(t)=lambda×UNC(t)+(1−lambda)×theta(t−1), where a higher lambda (e.g., lambda=0.2) may provide faster adaptation, where a lower lambda (e.g., lambda=0.05) may be more stable, where a default lambda (e.g., lambda=0.1) may balance both), and/or the like. Therefore, operation 304 may be configured to operate on any suitable data (e.g., current token UNC score, previous threshold theta, parameter lambda, etc.) and output any suitable data 304a, which may be indicative of any suitable information, including, but not limited to, any suitable updated threshold theta(t), current token UNC score, and/or the like, which may be utilized by any further operations. Therefore, operation 304 may enable O(1) per-token threshold update with a configurable memory horizon of approximately 1/lambda tokens.

At operation 305 of process 399, the system may determine a priority of each token's UNC score. Operation 305 may be configured to work on any suitable input(s) (e.g., data 304a, etc.), including, but not limited to, any suitable current token UNC score UNC(t) (e.g., from operation 303), current threshold theta(t) (e.g., from operation 304), parameter lambda, and/or the like. Operation 305 may be configured to carry out any suitable processing, including, but not limited to, determining if, for the current token t of the current iteration of loop 302, UNC(t)>adaptive threshold theta(t), where theta(t)=lambda×UNC(t)+(1−lambda)×theta(t−1), and if so, advancing to operation 306, and if not, advancing to operation 303 for the next iteration of loop 302. Therefore, operation 305 may be configured to operate on any suitable data (e.g., UNC(t) and theta(t), parameter lambda, etc.) to determine whether or not UNC(t) is greater than adaptive threshold theta(t), and providing any suitable data 305b (e.g., UNC(t), theta(t), lambda, etc.) to operation 306 when UNC(t) is greater than adaptive threshold theta(t), and providing any suitable data 305a (e.g., an instruction to advance to the next token for a next iteration of loop 302) when UNC(t) is not greater than adaptive threshold theta(t).

At operation 306 of process 399, the system may mark a boundary. For example, operation 306 may carry out any suitable boundary marking for any token exceeding threshold theta(t). Operation 306 may be configured to work on any suitable input(s) (e.g., data 305b, etc.), including, but not limited to, any suitable current token UNC score UNC(t) (e.g., from operation 303), current threshold theta(t) (e.g., from operation 304), parameter lambda, and/or the like. Operation 306 may be configured to carry out any suitable processing, including, but not limited to, mark any suitable boundary for the token t of the current iteration of loop 302 (e.g., boundaries.append(t)), applying any suitable constraints (e.g., constraints: min_gap=32, max_gap−512 tokens), and/or the like. Therefore, operation 306 may be configured to operate on any suitable data and output any suitable data 306a, which may be indicative of any suitable information, including, but not limited to, any suitable updated boundary candidate list, an instruction to advance to the next token for a next iteration of loop 302, and/or the like, which may be utilized by any further operations (e.g., operation 303 for the next iteration of loop 302). Once loop 302 has been carried out for every appropriate token, loop 302 may generate any suitable output data 302a, such as an updated boundary candidate list for all iterations of loop 302, and process 399 may advance from loop 302 to operation 307.

At operation 307 of process 399, the system may identify all boundary positions. For example, operation 307 may provide any suitable post-loop processing that may merge UNC and Fiedler boundaries. Operation 307 may be configured to work on any suitable input(s) (e.g., data 302a, data 208a, etc.), including, but not limited to, any suitable boundary candidates from loop 302 (e.g., from all iterations of operation 306 of loop 302), any suitable Fiedler zero-crossing (e.g., from operation 208 of process 299 of FIG. 2), and/or the like. Operation 307 may be configured to carry out any suitable processing, including, but not limited to, merging any suitable UNC-based boundaries (e.g., of data 302a) with any suitable Fiedler-based boundaries (e.g., of data 208a), keeping any boundaries supported by both criteria, resolving any conflicts using higher UNC, enforcing any min/max constraints, and/or the like. Therefore, operation 307 may be configured to operate on any suitable data (e.g., UNC-based boundaries, Fiedler-based boundaries, etc.) and output any suitable data 307a, which may be indicative of any suitable information, including, but not limited to, any suitable finalized boundary list (e.g., finalized boundary list: B={b1, b2, . . . , bm}), and/or the like, which may be utilized by any further operations. Therefore, operation 307 may be configured to use dual criterion, such as by combining statistical (e.g., EMA) criteria and structural (e.g., Fiedler) criteria to produce more semantically meaningful boundaries than either method may do on its own.

At operation 308 of process 399, the system may form memory units between boundaries. For example, operation 308 may create discrete memory units by partitioning at finalized boundary positions. Operation 308 may be configured to work on any suitable input(s) (e.g., data 307a, 309a, etc.), including, but not limited to, any suitable boundary positions (e.g., positions B from the finalized boundary list of data 307a from operation 307), any suitable original token sequence (e.g., token sequence T={t1, t2, . . . , tn} of data 390a of operation 300), and/or the like. Operation 308 may be configured to carry out any suitable processing, including, but not limited to, partitioning memory at various partitions into various memory units (e.g., partitions: Unit_k=T[b_k:b_{k+1}] for k=0 to m, where there may be a first unit: T[0:b1], a last unit: T[bm:n], etc.), and/or the like. Therefore, operation 308 may be configured to operate on any suitable data (e.g., boundary positions, token sequence, etc.) and output any suitable data 308a, which may be indicative of any suitable information, including, but not limited to, any suitable memory units (e.g., memory units {Unit1, Unit2, . . . , Unit_{m+1}}) with any suitable explicit boundary marker(s), and/or the like, which may be utilized by any further operations.

At operation 309 of process 399, the system may assign a UNC score to each memory unit. For example, operation 309 may compute an aggregate UNC score for each memory unit (e.g., to guide resource allocation). Operation 309 may be configured to work on any suitable input(s) (e.g., data 308a, 210a/214a, etc.), including, but not limited to, any suitable memory units (e.g., from data 308a from operation 308), any suitable token-level UNC scores (e.g., from process 299 of FIG. 2 (e.g., data 210a/214a)), and/or the like. Operation 309 may be configured to carry out any suitable processing, including, but not limited to, for each unit k: UNC(Unit_k)=max(UNC(ti)) for ti in Unit_k, where max strategy may ensure high-priority tokens elevate entire unit, and/or the like. Therefore, operation 309 may be configured to operate on any suitable data (e.g., memory units, token-level UNC scores, etc.) and output any suitable data 309a, which may be indicative of any suitable information, including, but not limited to, any suitable memory units with UNC scores (e.g., memory units with UNC scores: {(Unit1, UNC1), (Unit2, UNC2), . . . }), which may be referred to as “memory unit-level UNC scores”, and/or the like, which may be utilized by any further operations.

At operation 310 of process 399, the system may form an output package (e.g., memory units with boundaries). For example, operation 310 may provide a terminal node outputting segmented memory units for hierarchical storage allocation. Operation 310 may be configured to work on any suitable input(s) (e.g., data 309a, etc.), including, but not limited to, any suitable complete set of memory units with UNC scores (e.g., from operation 309), and/or the like. Operation 310 may be configured to carry out any suitable processing, including, but not limited to, packaging memory units, signaling completion of process 399, preparing handoff to resource allocation (e.g., process 499 of FIG. 4 (e.g., operation 400)), and/or the like. Therefore, operation 310 may be configured to operate on any suitable data (e.g., memory units with UNC scores, etc.) and output any suitable data 310a, which may be indicative of any suitable information, including, but not limited to, any suitable finalized memory unit structure with boundaries and UNC scores, and/or the like, which may be utilized by any further operations.

It is understood that the operations shown in process 399 of FIG. 3 are only illustrative and that existing operations may be modified or omitted, additional operations may be added, and the order of certain operations may be altered.

### FIG. 4

FIG. 4 is a flowchart of an illustrative process 499 for allocating memory resources (e.g., using a power-law formula (e.g., A(s)=k×(1/s\hat{ }rho))). For example, process 499 may assign memory resources to each unit based on its UNC score, implementing tiered storage with configurable resource distribution, and/or the like.

At operation 400 of process 499, a system (e.g., system 199 of FIG. 1B or otherwise) may obtain memory units with UNC scores. For example, operation 400 may provide an entry point for receiving memory units with computed UNC scores from boundary detection. Operation 400 may be configured to work on any suitable input(s) (e.g., data 490a, etc.), including, but not limited to, any suitable memory units with UNC scores (e.g., {(Unit1, UNC1), (Unit2, UNC2), . . . , (Unitm, UNCm)} (e.g., data 310a from operation 310 of process 399 of FIG. 3)), and/or the like. Operation 300 may be configured to carry out any suitable processing, including, but not limited to, validating all units have associated UNC scores, preparing units for an allocation loop (e.g., loop 420), initializing resource accounting, and/or the like. Therefore, operation 300 may be configured to operate on any suitable data (e.g., memory units with UNC scores, etc.) and output any suitable data 400a, which may be indicative of any suitable information, including, but not limited to, any suitable validated memory units ready for allocation processing, and/or the like, which may be utilized by any further operations.

At operation 401 of process 499, the system may configure allocation parameters. For example, operation 401 may configure power-law allocation parameters (e.g., total budget k, exponent rho, etc.) that may control total resources and/or distribution shape. Operation 401 may be configured to work on any suitable input(s) (e.g., data 400a, etc.), including, but not limited to, any suitable configuration (e.g., configuration: Total resource budget k (e.g., memory/compute)), any suitable power-law exponent (e.g., power-law exponent rho in [0.5, 2.0]), and/or the like. Operation 401 may be configured to carry out any suitable processing, including, but not limited to, setting any suitable total resource budget k (e.g., budget k=total available memory budget), setting any suitable exponent rho (e.g., rho controls skewness (e.g., rho<1.0 may be more uniform, rho=1.0 may be standard inverse (e.g., default), rho>1.0 may be aggressive high-priority favoritism), and/or the like. Therefore, operation 401 may be configured to operate on any suitable data and output any suitable data 401a, which may be indicative of any suitable information, including, but not limited to, any suitable configured parameters (e.g., parameters (k, rho)) for allocation computation, and/or the like, which may be utilized by any further operations. Therefore, operation 401 may be configured to enable tunability, where exponent rho may enable domain-specific optimization (e.g., technical documents may use rho=1.5, narrative text may use rho=0.8, etc.).

At a loop 402, one or more iterations of one or more operations 403, 404, 405, 406, 407, 408, 409, and/or 410 may be carried out between operation 401 and operation 411 of process 499 (e.g., for each one of memory units u from u=1 to u=m). At operation 403 of process 499, the system may obtain UNC score for memory unit u. For example, operation 403 may retrieve UNC(u) (e.g., UNC(u)=cached_UNC[u] or operation 403 may trigger real-time computation). Operation 403 may be configured to work on any suitable input(s) (e.g., data 400a, 401a, etc.), including, but not limited to, any suitable memory units and their UNC scores (e.g., from operation 400), and/or the like. Operation 403 may be configured to carry out any suitable processing, including, but not limited to, obtaining a UNC score UNC(u) for a particular one of unit u=1 to unit u=m of the current loop iteration of loop 402 and providing that UNC score UNC(u) (e.g., retrieving a memory unit score s=UNC(u), validating s>0, applying minimum smoothing (e.g., smoothing: s=max(s, 0.01)), etc.) as output data 403a, which may be utilized by any further operations (e.g., operation 404).

At operation 404 of process 499, the system may compute resource allocation. For example, operation 404 may calculate resource allocation using a power-law formula based on UNC score. Operation 404 may be configured to work on any suitable input(s) (e.g., data 401a, 403a, etc.), including, but not limited to, any suitable UNC score s (e.g., from operation 403 for the memory unit u of the current iteration of loop 402), any suitable parameters k and rho (e.g., from operation 401), and/or the like. Operation 404 may be configured to carry out any suitable processing, including, but not limited to, using a power-law (e.g., power-law: A(s)=k×(1/s\hat{ }rho)=k×s\hat{ }(−rho), where a higher UNC (e.g., score s) may be a lower allocation (e.g., surprising content may be rarer, may get more per unit (e.g., as an example, when k=1000 and rho=1.0, a UNC score s=0.8 may yield A=1250, while a UNC score s=0.2 may yield A=5000, etc.))), and/or the like. Therefore, operation 404 may be configured to operate on any suitable data (e.g., memory unit UNC score s, parameters k and rho, etc.) and output any suitable data 404a, which may be indicative of any suitable information, including, but not limited to, any suitable raw allocation value A(s) for current unit of current iteration of loop 402, and/or the like, which may be utilized by any further operations. Therefore, operation 404 may be configured to use an inverse power-law, which may counter-intuitively allocate MORE resources to HIGH UNC (e.g., surprising) content, prioritizing retention of novel, uncertain, and/or coherence-breaking information.

At operation 405 of process 499, the system may perform a high threshold check on the memory unit UNC score. For example, operation 405 may perform a first tier decision for highest-priority (e.g., full-fidelity) storage. Operation 405 may be configured to work on any suitable input(s) (e.g., data 403a, 404a, etc.), including, but not limited to, any suitable UNC score s for the current memory unit (e.g., as data 403a from operation 403), any suitable high threshold value (e.g., theta_high=0.7 or any other suitable value, and/or the like. Operation 405 may be configured to carry out any suitable processing, including, but not limited to, determining whether or not the UNC score s for the current memory unit u of the current iteration of loop 402 is greater than the high threshold value (e.g., IF s>theta_high) and if so, advance to operation 406 (e.g., which may include passing any suitable data 405a), otherwise (e.g., IF s≤theta_high) advance to operation 407 (e.g., which may include passing any suitable data 405b), and/or the like. Therefore, operation 405 may be configured to operate on any suitable data (e.g., score s, high threshold theta_high, etc.) to determine whether or not score s is greater than the high threshold, and providing any suitable data 405a to operation 406 when score s is greater than the high threshold, and providing any suitable data 405b to operation 407 when score s is not greater than the high threshold.

At operation 406 of process 499, the system may assign high resources to the current memory unit. For example, operation 406 may allocate high (e.g., maximum) resources for full-fidelity storage for the memory unit u of the current iteration of loop 402. Operation 406 may be configured to work on any suitable input(s) (e.g., data 405a, etc.), including, but not limited to, any suitable memory unit passing the high threshold check, and/or the like. Operation 406 may be configured to carry out any suitable processing, including, but not limited to, setting a tier to tier=HIGH, using Float32 storage, completing attention cache, performing no compression, creating coherence links to related units, and/or the like. Therefore, operation 406 may be configured to operate on any suitable data (e.g., data indicative of a memory unit passing a high threshold check, etc.) and output any suitable data 406a, which may be indicative of any suitable information, including, but not limited to, any suitable memory unit assigned to a high-priority tier with full resources, and/or the like, which may be utilized by any further operations.

At operation 407 of process 499, the system may perform a medium threshold check on the memory unit UNC score. For example, operation 407 may perform a second tier decision for medium-priority storage. Operation 407 may be configured to work on any suitable input(s) (e.g., data 403a, 404a, 405b, etc.), including, but not limited to, any suitable UNC score s for the current memory unit (e.g., as data 403a from operation 403), any suitable medium threshold value (e.g., theta_med=0.3 or any other suitable value, and/or the like. Operation 407 may be configured to carry out any suitable processing, including, but not limited to, determining whether or not the UNC score s for the current memory unit u of the current iteration of loop 402 is greater than the medium threshold value (e.g., IF s>theta_med) and if so, advance to operation 408 (e.g., which may include passing any suitable data 407a), otherwise (e.g., IF s≤theta_med) advance to operation 409 (e.g., which may include passing any suitable data 407b), and/or the like. Therefore, operation 407 may be configured to operate on any suitable data (e.g., score s, medium threshold theta_med, etc.) to determine whether or not score s is greater than the medium threshold, and providing any suitable data 407a to operation 408 when score s is greater than the medium threshold, and providing any suitable data 407b to operation 409 when score s is not greater than the medium threshold.

At operation 408 of process 499, the system may assign medium resources to the current memory unit. For example, operation 408 may allocate medium or moderate (e.g., compressed) resources for the memory unit u of the current iteration of loop 402. Operation 408 may be configured to work on any suitable input(s) (e.g., data 407a, etc.), including, but not limited to, any suitable memory unit passing the medium threshold check, and/or the like. Operation 408 may be configured to carry out any suitable processing, including, but not limited to, setting a tier to tier=MEDIUM, using Float16/int8 quantization, performing 2-4× compression, maintaining bidirectional coherence links, and/or the like. Therefore, operation 408 may be configured to operate on any suitable data (e.g., data indicative of a memory unit passing a medium threshold check, etc.) and output any suitable data 408a, which may be indicative of any suitable information, including, but not limited to, any suitable memory unit assigned to a medium-priority tier with compression, and/or the like, which may be utilized by any further operations.

At operation 409 of process 499, the system may assign low resources to the current memory unit. For example, operation 409 may allocate minimal or low resources (e.g., for dormant storage with resurrection capability) for the memory unit u of the current iteration of loop 402. Operation 409 may be configured to work on any suitable input(s) (e.g., data 407b, etc.), including, but not limited to, any suitable memory unit not passing the medium threshold check, and/or the like. Operation 409 may be configured to carry out any suitable processing, including, but not limited to, setting a tier to tier=LOW (e.g., DORMANT), using 10-50× compression, using summary vectors only, using centroid embedding, preserving coherence links for resurrection, and/or the like. Therefore, operation 409 may be configured to operate on any suitable data (e.g., data indicative of a memory unit not passing a medium threshold check, etc.) and output any suitable data 409a, which may be indicative of any suitable information, including, but not limited to, any suitable memory unit assigned to a low-priority tier (e.g., a dormant tier), and/or the like, which may be utilized by any further operations. Such dormant memory units may be configured to preserve coherence links, thereby enabling resurrection when related high-priority content is accessed (e.g., rather than discarding). The number of thresholds (e.g., number of tiers) and the threshold values (e.g., 0.7, 0.3) may be any suitable values and may be configurable system parameters, which may have empirical defaults, stored in config, tunable per-deployment/domain, learnable via gradient/RL/meta-learning, and/or the like.

At operation 410 of process 499, the system may store unit with allocation. For example, operation 410 may persist the memory unit of the current iteration of loop 402 with its assigned tier and resource allocation. Operation 410 may be configured to work on any suitable input(s) (e.g., data 406a, 408a, data 409a, and/or any other suitable data), including, but not limited to, the memory unit u of the current iteration of loop 402, its assigned tier (e.g., of one of operations 406, 408, and 409 (e.g., of data 406a, 408a, or data 409a), its computed allocation A(s) (e.g., of data 404a of operation 404), and/or the like. Operation 410 may be configured to carry out any suitable processing, including, but not limited to, storing in tier-specific structure, recording allocation metadata, updating any suitable coherence link graph, and/or the like. This may be distributed by tier, where high-priority may be stored in fast memory, medium may be compressed, low may be highly compressed with relationships preserved. Metadata may include any suitable data, including, but not limited to, unit ID, tier, allocation, scores, boundaries, relationships, compression, timestamps, access stats, and/or the like. Schemas may be implementation-dependent. Therefore, operation 410 may be configured to operate on any suitable data and output any suitable data 410a, which may be indicative of any suitable information, including, but not limited to, any suitable stored memory unit, any suitable updated storage structure, any suitable instruction to advance to the next memory unit for a next iteration of loop 402, and/or the like, which may be utilized by any further operations (e.g., operation 403 for the next iteration of loop 402). Once loop 402 has been carried out for every appropriate memory unit, an updated memory structure may be indicative of the resource allocations for all appropriate memory units, and loop 402 may generate any suitable output data 402a, such as data including all raw allocations (e.g., allocations {A(s1), A(s2), . . . , A(sm)} of all operations 404 of loop 402) and a total budget k of loop 402, and process 499 may advance from loop 402 to operation 411.

At operation 411 of process 499, the system may normalize allocations to budget. For example, operation 411 may provide post-loop normalization (e.g., for ensuring total allocations respect budget constraint). Operation 411 may be configured to work on any suitable input(s) (e.g., data 402a, etc.), including, but not limited to, all raw allocations (e.g., allocations {A(s1), A(s2), . . . , A(sm)}), total budget k, and/or the like. Operation 411 may be configured to carry out any suitable processing, including, but not limited to, normalizing allocations respecting budget (e.g., allocation A_total=SUM A(si), where norm=k/A_total, where A_norm(si)=A(si)×norm, which may guarantee SUM A_norm(si)=k), and/or the like. Therefore, operation 411 may be configured to operate on any suitable data (e.g., raw allocations and budget, etc.) and output any suitable data 411a, which may be indicative of any suitable information, including, but not limited to, any suitable normalized allocations respecting budget constraint, and/or the like, which may be utilized by any further operations. Therefore, operation 411 may be configured to enforce budget, whereby such normalization may ensure predictable memory usage regardless of content characteristics, which may be critical for production deployment. Normalization benefits may include, but are not limited to, predictable usage, service level agreement (“SLA”) compliance, graceful handling, cost control, stability, fairness, and/or the like. Budget may be determined via config, runtime detection, application limits, dynamic adjustment, learned optimization, and/or the like. Power-law may be one embodiment, while any monotonically decreasing function may be within scope of the disclosure.

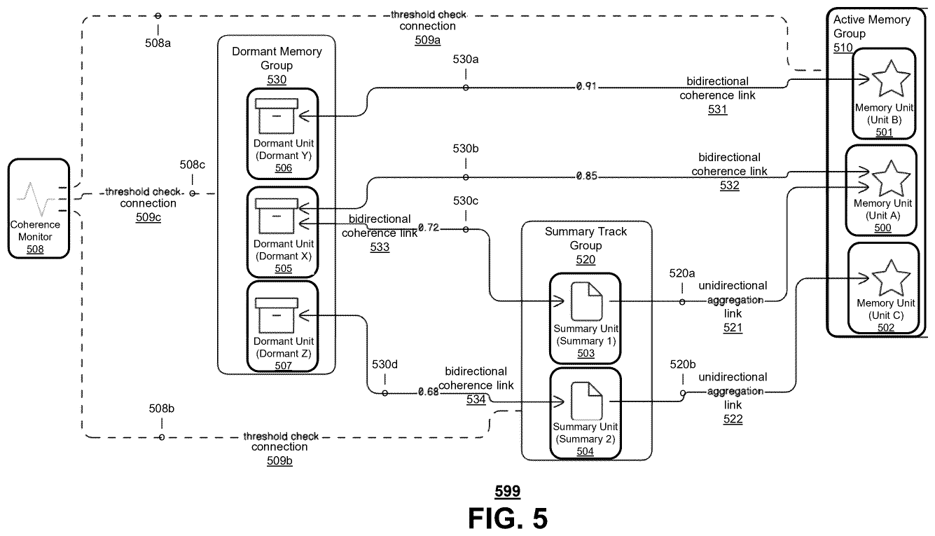

At operation 412 of process 499, the system may form a complete allocated memory structure. For example, operation 412 may provide a terminal node outputting a complete hierarchical memory structure. Operation 412 may be configured to work on any suitable input(s) (e.g., data 411a, etc.), including, but not limited to, any suitable normalized allocations (e.g., from operation 411) and/or any suitable complete tier assignments (e.g., from loop 402), and/or the like. Operation 412 may be configured to carry out any suitable processing, including, but not limited to, packaging a final structure (e.g., high-tier (e.g., full fidelity), medium-tier (e.g., compressed), low-tier (e.g., dormant)), providing a coherence link graph, signaling completion of process 499, and/or the like. Therefore, operation 412 may be configured to operate on any suitable data (e.g., normalized allocations, tier assignments, etc.) and output any suitable data 412a, which may be indicative of any suitable information, including, but not limited to, any suitable complete hierarchical memory (e.g., memory ready for operation), and/or the like, which may be utilized by any further operations (e.g., by operations 107-111 of process 199 of FIG. 1B, structure 599 of FIG. 5, etc.).

It is understood that the operations shown in process 499 of FIG. 4 are only illustrative and that existing operations may be modified or omitted, additional operations may be added, and the order of certain operations may be altered.

### FIG. 5

FIG. 5 is an architecture diagram showing a three-tier memory system or structure 599 with coherence links, such as a coherence-link architecture including a high fidelity active tier memory group 510 (see, e.g., memory units 500, 501, and 502 (e.g., unit A, unit B, and unit C, respectively)), a medium fidelity summary track tier memory group 520 (see, e.g., summaries 503 and 504 (e.g., summary 1 and summary 2, respectively)), a low fidelity dormant tier memory group 530 (see, e.g., dormant units 505, 506, 507 (e.g., dormant X, dormant Y, dormant Z, respectively)), and a coherence monitor 508. In some embodiments, any suitable threshold check connection 509a may exist between monitor 508 and active memory group 510 (e.g., for any suitable data 508a), any suitable threshold check connection 509b may exist between monitor 508 and summary track group 520 (e.g., for any suitable data 508b), and/or any suitable threshold check connection 509c may exist between monitor 508 and dormant memory group 530 (e.g., for any suitable data 508c). In some embodiments, any suitable (e.g., unidirectional) aggregation link 521 may extend from unit 503 to unit 500 (e.g., for any suitable data 520a), any suitable (e.g., unidirectional) aggregation link 522 may extend from unit 504 to unit 502 (e.g., for any suitable data 520b), and/or the like. In some embodiments, any suitable (e.g., bidirectional) coherence link 531 (e.g., of any suitable strength value (e.g., 0.91) of any suitable relation (e.g., causal)) may extend (e.g., for any suitable data 530a) between unit 506 (e.g., as a source) and unit 501 (e.g., as a target), any suitable (e.g., bidirectional) coherence link 532 (e.g., of any suitable strength value (e.g., 0.85) of any suitable relation (e.g., referential)) may extend (e.g., for any suitable data 530b) between unit 505 (e.g., as a source) and unit 500 (e.g., as a target), any suitable (e.g., bidirectional) coherence link 533 (e.g., of any suitable strength value (e.g., 0.72) of any suitable relation (e.g., thematic)) may extend (e.g., for any suitable data 530c) between unit 505 (e.g., as a source) and unit 503 (e.g., as a target), any suitable (e.g., bidirectional) coherence link 534 (e.g., of any suitable strength value (e.g., 0.68) of any suitable relation (e.g., temporal)) may extend (e.g., for any suitable data 530d) between unit 507 (e.g., as a source) and unit 504 (e.g., as a target), and/or the like.

One or more memory units (e.g., memory units 500, 501, and 502 (e.g., unit A, unit B, and unit C, respectively)) of active memory group 510 may be full embeddings serving as coherence link anchor points for resurrection triggers. One, some, or each such memory unit may be configured as a complete embedding, with full attention cache, one or more coherence links from one or more dormant units, one or more aggregation links from one or more summary units, and/or the like. One, some, or each memory unit of active memory group 510 may be configured for float32 storage, with complete positional encoding preserved, for serving as a link endpoint triggering dormant resurrection, and/or the like. One, some, or each memory unit of active memory group 510 may be configured to provide a full-fidelity representation, one or more resurrection trigger points, and/or the like. One, some, or each memory unit of active memory group 510 may be configured to provide at least a portion of module 107 of system 199 of FIG. 1B. One, some, or each memory unit of active memory group 510 may be configured to provide a high-fidelity anchor, where access to these units can trigger resurrection of semantically related dormant content.

One or more summary units (e.g., summary units 503 and 504 (e.g., summary 1 and summary 2, respectively)) of summary track group 520 may be a medium-fidelity compressed summary bridging high and dormant tiers. One, some, or each such summary unit may be configured as a compressed embedding, with one or more coherence links from one or more dormant units, one or more aggregation sources for one or more memory units of an active memory group, and/or the like. One, some, or each summary unit of summary track group 520 may be configured for 2-4× compression, to generate aggregation pathways to an active tier, for any suitable intermediate resurrection layer, and/or the like. One, some, or each summary unit of summary track group 520 may be configured to provide any suitable compressed summary, any suitable aggregation output to any suitable active tier, and/or the like. One, some, or each summary unit of summary track group 520 may be configured to provide at least a portion of module 108 of system 199 of FIG. 1B and/or to provide a bridge between memory unit(s) of active memory group 510 and dormant unit(s) of dormant memory group 530. One, some, or each summary unit of summary track group 520 may be configured to provide hierarchical bridging, which may enable gradual context expansion from dormant through summary to active.

Dormant unit 505 (e.g., dormant X) of dormant memory group 530 may be a dormant unit with links to both active and summary tiers. Dormant unit 505 may be configured as a summary vector. Dormant unit 505 may be configured for minimal storage, for dual resurrection paths (e.g., both link 533 with a strength 0.72 and link 532 with a strength 0.85 may be above a threshold (e.g., threshold of 0.7)), and/or to resurrect via either path, and/or the like. Dormant unit 505 may be configured to provide any suitable dual resurrection capability, and/or the like. Dormant unit 505 of dormant memory group 530 may be configured to provide at least a portion of module 109 of system 199 of FIG. 1B and/or to provide links to both high and medium tiers. Dormant unit 505 may be configured to provide a dual path, as it may resurrect via high-fidelity tier or summary tier, thereby demonstrating flexible resurrection architecture.

Dormant unit 506 (e.g., dormant Y) of dormant memory group 530 may be a dormant unit with the highest coherence strength in the system. Dormant unit 506 may be configured as a summary vector. Dormant unit 506 may be configured for minimal storage, as an intermediate resurrection candidate when memory unit 501 is accessed (e.g., link 531 with a strength 0.91), to be a highest-priority dormant unit, and/or the like. Dormant unit 506 may be configured to provide any suitable high-priority resurrection link, and/or the like. Dormant unit 506 of dormant memory group 530 may be configured to provide at least a portion of module 109 of system 199 of FIG. 1B and/or to link to a high tier. Dormant unit 507 may be configured to provide a strongest link, as it may demonstrate strong cross-tier relationship capability for immediate context expansion.

Dormant unit 507 (e.g., dormant Z) of dormant memory group 530 may be a dormant unit with a maintained but non-triggering link. Dormant unit 507 may be configured as a summary vector. Dormant unit 507 may be configured with a link below a threshold strength (e.g., link 534 with a strength 0.68 that may be below a threshold (e.g., threshold of 0.7)). Dormant unit 507 may be configured for minimal storage, with a link preserved for potential future strengthening, not to auto-resurrect, and/or the like. Dormant unit 507 may be configured to provide any suitable sub-threshold link (e.g., maintained but not triggered), and/or the like. Dormant unit 507 of dormant memory group 530 may be configured to provide at least a portion of module 109 of system 199 of FIG. 1B and/or to link to a high tier.

Coherence monitor 508 may be a central resurrection trigger component (e.g., for evaluating coherence-based activation). Coherence monitor 508 may be configured with all threshold check connections, any suitable query context, any suitable resurrection threshold (e.g., theta_res=0.7), and/or the like. Coherence monitor 508 may be configured to monitor activations on query, to compute relevance (e.g., relevance=strength×query_similarity), to trigger resurrection when relevance>threshold, and/or the like. Coherence monitor 508 may be configured for resurrection triggers, to provide threshold signals (e.g., to process 699 of FIG. 6), and/or the like. Coherence monitor 508 may be configured as a central hub that may connect all tiers, provide an interface with query processing (e.g., query processing of process 699 of FIG. 6 (see, e.g., query processor 630)), and/or the like. Coherence monitor 508 may be configured as core logic, where coherence-triggered activation may be distinct from attention-based retrieval, where resurrection may be based on pre-computed semantic relationships and not query-time attention, and/or the like.

### FIG. 6

FIG. 6 is a flowchart of an illustrative process 699 for query processing (e.g., with coherence-triggered resurrection). For example, process 699 may demonstrate how queries may access active memory and trigger resurrection of semantically related dormant content (e.g., query processing with context resurrection (e.g., via coherence-triggered activation)).

Process 699 may involve any suitable user query 620 (e.g., an end user submitting a query (e.g., user U (e.g., using any suitable device 60))), any suitable query processor 630 (e.g., any suitable central processing unit or otherwise (e.g., processor 12)), any suitable active memory 640 (e.g., any suitable high-fidelity memory store (e.g., memory 13)), any suitable coherence monitor 650 (e.g., any suitable threshold evaluation component (e.g., processor 12)), any suitable dormant memory 660 (e.g., any suitable low-fidelity memory store (e.g., memory 13)), and/or the like.

At operation 600 of process 699, a system (e.g., system 199 of FIG. 1B or otherwise (e.g., a system involving user query 620, query processor 630, active memory 640, coherence monitor 650, dormant memory 660, etc.) may submit a query. For example, operation 600 may provide any suitable user query for initiating any suitable retrieval process. Operation 600 may be configured to work on any suitable input(s), including, but not limited to, any suitable query (e.g., a query Q) from any suitable user, any suitable tokenization parameters, and/or the like (e.g., via any suitable interface(s) for any suitable purpose(s)). Operation 601 may be configured to carry out any suitable processing, including, but not limited to, tokenizing a query, generating any suitable query embedding (e.g., query embedding q), preparing for similarity search (e.g., a cosine similarity search), and/or the like. Therefore, operation 601 may be configured to operate on any suitable data (e.g., a query Q, tokenization parameters, etc.) and output any suitable data, which may be indicative of any suitable information, including, but not limited to, any suitable query embedding (e.g., embedding q) that may be ready for search, and/or the like, which may be utilized by any further operations (e.g., an entry point to active memory search).

At operation 602 of process 699, the system (e.g., memory 640) may search active memory (e.g., search active units). For example, operation 602 may conduct a similarity search (e.g., a cosine similarity search) against a high-fidelity tier. Operation 602 may be configured to work on any suitable input(s) (e.g., data from operation 600, etc.), including, but not limited to, any suitable query embedding (e.g., query embedding q (e.g., from operation 600)), any suitable high-fidelity units (e.g., units 500-502 of FIG. 5), any suitable parameters (e.g., parameters: top-k=10, theta_sim=0.5, etc.), and/or the like. Operation 602 may be configured to carry out any suitable processing, including, but not limited to, computing any suitable similarity (e.g., cosine similarity) between query embedding q and all active units; returning top-k matches above threshold, including coherence link references, and/or the like. Therefore, operation 602 may be configured to operate on any suitable data (e.g., query embedding, high-fidelity units, parameters, etc.) and output any suitable data, which may be indicative of any suitable information, including, but not limited to, any suitable match list (e.g., match list M with coherence references), and/or the like, which may be utilized by any further operations (e.g., by query processor 630).

At operation 603 of process 699, the system (e.g., processor 630) may check coherence links. For example, operation 603 may request coherence evaluation for dormant units linked to matches. Operation 603 may be configured to work on any suitable input(s) (e.g., data of operation 602, etc.), including, but not limited to, any suitable matched coherence links (e.g., from operation 602), any suitable resurrection threshold (e.g., resurrection threshold theta_res=0.7), and/or the like. Operation 603 may be configured to carry out any suitable processing, including, but not limited to, extracting any suitable link(s) from any suitable matched unit(s), preparing any suitable link metadata, sending any suitable evaluation request(s) (e.g., to coherence monitor 650 (e.g., monitor 508 of FIG. 5)), and/or the like. Therefore, operation 603 may be configured to operate on any suitable data (e.g., matched coherence link(s), threshold(s), etc.) and output any suitable data, which may be indicative of any suitable information, including, but not limited to, any suitable any suitable evaluation request(s) (e.g., to coherence monitor 650), and/or the like, which may be utilized by any further operations. Therefore, operation 603 may be configured to provide any suitable critical resurrection decision point. Therefore, operation 603 may enable the system to be coherence-triggered, such as based on pre-computed relationships, not query-time attention calculation, to provide a novel retrieval mechanism.

At operation 604 of process 699, the system (e.g., monitor 650) may evaluate dormant links. For example, operation 604 may evaluate resurrection eligibility. Operation 604 may be configured to work on any suitable input(s) (e.g., data of operation 603, etc.), including, but not limited to, any suitable link data, dormant unit metadata, resurrection threshold theta_res, and/or the like. Operation 604 may be configured to carry out any suitable processing, including, but not limited to, for each dormant link, determining activation (e.g., activation=strength×query_relevance) and if such activation is greater than resurrection threshold theta res then mark the link for resurrection, and/or the like. Therefore, operation 604 may be configured to operate on any suitable data (e.g., link data, dormant unit metadata, resurrection threshold, etc.) and output any suitable data, which may be indicative of any suitable information, including, but not limited to, any suitable resurrection candidate(s), any suitable activation score(s), and/or the like, which may be utilized by any further operations. Therefore, operation 604 may be configured to trigger any suitable conditional branch (e.g., branch 605 or branch 608).

For a triggered positive branch 605, when coherence is greater than the threshold, at operation 606 of process 699, the system may resurrect context. For example, operation 606 may decompress and transfer any suitable dormant unit(s) to active. Operation 606 may be configured to work on any suitable input(s), including, but not limited to, any suitable eligible dormant unit ID(s), and/or the like. Operation 606 may be configured to carry out any suitable processing, including, but not limited to, retrieve any suitable summary vector(s) from dormant storage (e.g., for branch 605), decompress via learned expansion network (e.g., 10-50×), transfer reconstructed embeddings to active memory (e.g., memory 640), and/or the like. Therefore, operation 606 may be configured to operate on any suitable data (e.g., eligible dormant unit ID(s), etc.) and output any suitable data, which may be indicative of any suitable information, including, but not limited to, any suitable resurrected embedding(s) that may be transferred to active memory, and/or the like, which may be utilized by any further operations (e.g., operation 607). Therefore, branch 605 and its operation 606 may be configured to be a true path or alt condition. This may enable any suitable learned expansion, where any suitable neural network may reconstruct full representations from compressed summaries, enabling efficient storage without permanent information loss.

At operation 607 of process 699, the system (e.g., active memory 640) may provide resurrected context. For example, operation 607 may involve active memory 640 forwarding resurrected content (e.g., to processor 630) for response assembly. Operation 607 may be configured to work on any suitable input(s), including, but not limited to, any suitable resurrected data (e.g., from operation 606), and/or the like. Operation 607 may be configured to carry out any suitable processing, including, but not limited to, integrating any suitable resurrected units with original matches, forwarding combined context to query processor 630, and/or the like. Therefore, operation 607 may be configured to operate on any suitable data (e.g., resurrected data, etc.) and output any suitable data, which may be indicative of any suitable information, including, but not limited to, any suitable combined context (e.g., original matches+resurrected units), and/or the like, which may be utilized by any further operations (e.g., operation 610). Therefore, operation 607 may be configured to provide context expansion, which may surface related historical content that was stored in a dormant tier, thereby providing richer response context.

For a triggered positive branch 608, when coherence is not greater than the threshold, at operation 609 of process 699, the system may skip any resurrection. For example, operation 609 may not trigger any resurrection but may advance to operation 610. Operation 609 may be configured to work on any suitable input(s), including, but not limited to, any suitable activation scores below theta_res, and/or the like. Operation 609 may be configured to carry out any suitable processing, including, but not limited to, generate a no-resurrection signal (e.g., for branch 608), log for potential threshold optimization, and/or the like. Therefore, operation 609 may be configured to operate on any suitable data (e.g., activation scores below theta_res, etc.) and output any suitable data, which may be indicative of any suitable information, including, but not limited to, any suitable no-resurrection signal, and/or the like, which may be utilized by any further operations (e.g., operation 610). Therefore, branch 608 and its operation 609 may be configured to be an alternative path or else condition to that of branch 605 and operations 606 and 607.

At operation 610 of process 699, the system may return a response. For example, operation 610 may provide a final response assembly (e.g., combining matched and resurrected content). Operation 610 may be configured to work on any suitable input(s) (e.g., data of operation 602 and/or data of operation 607), including, but not limited to, any suitable matched unit(s) and any suitable resurrected unit(s) (e.g., if any), and/or the like. Operation 610 may be configured to carry out any suitable processing, including, but not limited to, assembling complete context, ranking by combined relevance, formatting a response, returning the response to the user (e.g., via any suitable interface(s) for any suitable purpose(s)), and/or the like.

Therefore, operation 610 may be configured to operate on any suitable data (e.g., matched unit(s), resurrected unit(s), and/or the like) and output any suitable data, which may be indicative of any suitable information, including, but not limited to, any suitable final response with integrated context, and/or the like, which may be utilized by any further operation(s) for any suitable purpose(s). Therefore, operation 610 may be configured to complete a query cycle. This may enable a unified response, which may seamlessly integrate directly matched and resurrected content for comprehensive answers.

It is understood that the operations shown in process 699 of FIG. 6 are only illustrative and that existing operations may be modified or omitted, additional operations may be added, and the order of certain operations may be altered.

### Example Scenario

The following is provided as an example scenario of a processing pipeline using the systems and processes described herein, with specific numerical values demonstrating the UNC attention mechanism and data flow. The particular scenario configuration may include an input document parameter provided as a medical research paper on longitudinal patient cardiac outcomes, a token count parameter provided as 100,000 tokens (e.g., approximately 75,000 words), a query parameter provided as “What were the cardiac outcomes for patients with prior diabetes?”, a UNC weights parameter provided as alpha=0.3 (Uncertainty), beta=0.4 (Novelty), and gamma=0.3 (Coherence), and a power-law exponent parameter provided as rho=1.0 and EMA smoothing lambda=0.1.

A first phase of this particular scenario may include any suitable system architecture initialization, as may be shown by FIG. 1B. The 100,000-token document may enter system architecture 199 of FIG. 1B (e.g., using module 120 of FIG. 1B). Uncertainty calculator 100 may be configured to receive attention probability distributions from 24 transformer layers, compute Shannon entropy for each token position, and identify 847 high-uncertainty regions (entropy>0.7) in ambiguous medical terminology. Novelty calculator 101 may be configured to aggregate layer-specific information content with weights (e.g., early layers (1-8) weight=0.2, middle layers (9-16) weight=0.5, late layers (17-24) weight=0.3) and detect 1,203 high-novelty tokens exceeding local baseline by 2 standard deviations. Coherence calculator 102 may be configured to construct a k=8 nearest neighbor graph over token embeddings, compute Fiedler vector via 15-iteration power method, and identify 312 Fiedler zero-crossings marking natural semantic boundaries. UNC score combiner 103 may be configured to fuse components (e.g., UNC(t)=0.3×U(t)+0.4×N(t)+0.3×C(t)) and output 100,000 UNC scores ranging [0.12, 0.94].

A second phase of this particular scenario may include such UNC score computation for each token (e.g., using engine 130 of FIG. 1B), as may be shown by FIG. 2, where parallel computation paths may execute concurrently. Various data provided by system 199 of FIG. 1B may be output to process 299 of FIG. 2, including, but not limited to, raw attention logits, layer hidden states, token embeddings, and/or the like. Operations 201 and 202 may use any suitable input(s), including attention logits, to carry out any suitable processing, including softmax normalizing and Shannon entropy per position, for providing any suitable output, such as U=[0.23, 0.67, 0.45, . . . ]. Operations 201 and 203-205 may use any suitable input(s), including layer hidden states, to carry out any suitable processing, including IC aggregation (e.g., 0.2×IC_early+0.5×IC_mid+0.3×IC_late), for providing any suitable output, such as N=[0.31, 0.89, 0.52, . . . ]. Operations 201 and 206-209 may use any suitable input(s), including token embeddings, to carry out any suitable processing, including k-NN graph, Laplacian, and Fiedler extraction (15 iter), for providing any suitable output, such as C=[0.78, 0.45, 0.91, . . . ]. Operations 210-214 may use any suitable input(s), including U, N, and C vectors, to carry out any suitable processing, including weighted fusion (e.g., alpha×U+beta×N+gamma×C), for providing any suitable output, such as UNC=[0.42, 0.71, 0.58, . . . ]. A particular example of such computation for a particular token t=15,847 (“myocardial”) may include U(15847)=0.72 (high entropy: multiple cardiac contexts), N(15847)=0.85 (novel term introducing new clinical findings), C(15847)=0.63 (moderate coherence with surrounding terminology), and UNC(15847)=0.3×(0.72)+0.4×(0.85)+0.3×(0.63)=0.745.

A third phase of this particular scenario may include memory unit boundary detection (e.g., using module 140 of FIG. 1B), as may be shown by FIG. 3, where an adaptive EMA threshold mechanism may segment the document. Various data provided by system 199 of FIG. 1B may be output to process 399 of FIG. 3, including, but not limited to, the 100,000 UNC scores, the 312 Fiedler zero-crossing positions, and/or the like. Operation 301 may be configured to initialize an EMA threshold as theta(0)=mean(UNC[1:32])=0.48. Operation 304 may be configured to update the EMA threshold per token as theta(t)=0.1×UNC(t)+0.9×theta(t−1), where the threshold may adapt from 0.48 to range [0.41, 0.67]. Operations 305 and 306 may be configured to mark boundary where UNC(t)>theta(t), so as to identify 1,847 candidate boundaries. Operations 307-310 may be configured to merge dual-criterion, intersect with the 312 Fiedler zero-crossings, enforce min=32/max=512 tokens, for a final result of 287 memory units. Various particular examples of such resulting memory units may include a memory unit Unit_001 with a token range [0, 127], a size of 128 tokens, a max UNC of 0.52, and a content type “Abstract,” a memory unit Unit_047 with a token range [15680, 16191], a size of 512 tokens, a max UNC of 0.89, and a content type “Cardiac Outcomes Section,” a memory unit Unit_112 with a token range [45312, 45600], a size of 289 tokens, a max UNC of 0.91, and a content type “Diabetes Cohort Analysis,” and a memory unit Unit_287 with a token range [99488, 99999], a size of 512 tokens, a max UNC of 0.45, and a content type “References.”

A fourth phase of this particular scenario may include resource allocation (e.g., using module 140 of FIG. 1B), as may be shown by FIG. 4, where a power-law formula may allocate computational and storage resources. Various data provided by system 199 of FIG. 1B may be output to process 499 of FIG. 4, including, but not limited to, the 287 memory units with boundaries and per-unit max UNC scores, and/or the like. Operation 404 may be configured to initialize an EMA threshold as theta(0)=mean(UNC[1:32])=0.48. Operation 304 may be configured to use a power-law formula: A(s)=k/s\hat{ }rho, where k=total_budget, rho=1.0, and s=UNC score. Tier assignment results may include 43 memory units being a high tier (e.g., for module 107 of system 199) with a UNC range greater than 0.7 for storage as float 32 and full KV cache and for no compression (e.g., 1× compression), 89 memory units being a medium tier (e.g., for module 108 of system 199) with a UNC range between 0.3 and 0.7 for storage as float 16 and partial cache and for 2-4× compression, and 155 memory units being a dormant tier (e.g., for module 109 of system 199) with a UNC range less than 0.3 for storage as summary vectors only and for 10-50× compression. This may result in significant memory savings, which may be calculated for a standard transformer as 100K×100K×4 bytes=40 GB for full attention, and ~23.3 GB for baseline, but for this particular scenario of a hierarchical system of this disclosure as 43 units full (1.7 GB)+89 units compressed (1.1 GB)+155 units dormant (0.3 GB)=3.1 GB (7.5× reduction (e.g., for 100,000 tokens). This may be achieved via tier-based precision, selective retention, and progressive compression.

A fifth phase of this particular scenario may include coherence link architecture (e.g., using module 150 of FIG. 1B), as may be shown by FIG. 5, where a coherence link manager or coherence monitor 508 may be configured to establish bidirectional semantic relationships. Various data provided by system 199 of FIG. 1B may be output to system 599 of FIG. 5, including, but not limited to, the 287 memory units assigned to various (e.g., 3) tiers with various compression ratios. Sample coherence links for the medical research paper input document of the particular scenario may include a link between a source (Dormant) memory unit Unit_023 (“Demographics”) and a target (Active) memory unit Unit_112 (“Diabetes Cohort Analysis”) with a strength of 0.87 and a referential relation with a “Demographics->Cohort” semantic link, a link between a source (Dormant) memory unit Unit_056 (“Prior Cardiac”) and a target (Active) memory unit Unit_047 (“Cardiac Outcomes Section”) with a strength of 0.91 and a causal relation with a “History->Outcomes” semantic link, a link between a source (Dormant) memory unit Unit_089 (“Medications”) and a target (Active) memory unit Unit_047 (“Cardiac Outcomes Section”) with a strength of 0.73 and a causal relation with a “Treatment->Response” semantic link, and a link between a source (Dormant) memory unit Unit_134 (“Methods”) and a target (Active) memory unit Unit_112 (“Diabetes Cohort Analysis”) with a strength of 0.68 and a thematic relation with a “Methods->Results” semantic link. The scenario may have any suitable link statistics, such as 423 total links, 147 high-strength (>0.7) links, 0.64 average link strength, 2.7 links per dormant unit, and/or the like.

A sixth phase of this particular scenario may include query processing with resurrection, as may be shown by FIG. 6. Various data provided by system 199 of FIG. 1B may be output to process 699 of FIG. 6, including, but not limited to, three-tier memory with 423 coherence links ready for query processing, such as for processing the scenario query of “What were the cardiac outcomes for patients with prior diabetes?”. Operations 600 and 601 (e.g., query submission) may be configured to tokenize the query Q, generate any suitable query embedding q, and enable similarity search (e.g., a cosine similarity search) against the 43 high-tier units. Operation 602 (e.g., active memory search) may return top matches: Unit_047 (sim=0.94), Unit_112 (sim=0.89), Unit_078 (sim=0.71). Operations 603 and 604 (e.g., coherence evaluation) may evaluate dormant links, where activation=strength×query_relevance, such that Unit_056: 0.91×0.82=0.746>0.7 threshold->RESURRECT, Unit_023: 0.87×0.76=0.661<0.7 threshold->SKIP, and Unit_089: 0.73×0.98=0.715>0.7 threshold->RESURRECT. Operations 606 and 607 (e.g., resurrection) may have dormant memory retrieve summary vectors for Unit_056 and Unit_089, where learned expansion network reconstructs full embeddings (e.g., 10-50× decompression). Operation 610 (e.g., response assembly) may combine 3 direct matches and 2 resurrected units, and may rank by combined relevance.

Therefore, a final query response for this particular scenario may include 5 units returned (3 direct and 2 resurrected via coherence links), 2,147 total context tokens (as compared to 100,000 tokens of the full document, resulting in a 97.9% noise reduction), 23 ms query latency (as compared to 89 ms baseline, resulting in 4.6× faster solution), 3.1 GB memory used (as compared to ~23.3 GB baseline, resulting in 7.5× reduction), and a resurrection success of 2 of 3 evaluated dormant units (66% coherence threshold effectiveness). FIG. 1 may receive 100,000 raw tokens and perform component extraction to provide attention logits and hidden states and embeddings, FIG. 2 may receive logits and states and embeddings and perform parallel U/N/C computation to provide 100,000 UNC scores [0.12-0.94], FIG. 3 may receive UNC scores and Fiedler zero-crossing positions and perform EMA thresholding and dual-criterion merging to provide 287 memory units with boundaries, FIG. 4 may receive 287 memory units and max UNC and perform power-law formula allocation (A(s)=k/s\hat{ }rho) to provide 43 high units and 89 medium units and 155 dormant units, FIG. 5 may receive tiered units and perform coherence link construction to provide 423 bidirectional semantic links, and FIG. 6 may receive a query and linked memory and perform search and coherence resurrection to provide 5 relevant units in 23 milliseconds (ms).

Therefore, systems and methods of this disclosure may provide significant improvements over other solutions. As just one example, this disclosure may provide three-component UNC fusion (e.g., model uncertainty via attention entropy, information novelty via layer-specific surprise computation, structural coherence via graph-based connectivity analysis (e.g., with trainable combination)), while no previous solutions combine entropy uncertainty, multi-layer novelty, and graph-theoretic coherence (e.g., for attention weighting). As another example, this disclosure may provide multi-scale layer-specific novelty, which may aggregate early/mid/late layers, as opposed to a single KL divergence for sequence-level event boundaries. This disclosure may provide a novelty-based approach that may focus on training, not inference-time attention. As another example, this disclosure may provide Fiedler-based coherence, where a k-NN graph with spectral analysis may achieve O(n log n) computational complexity, as opposed to O(n\hat{ }2) computational complexity. As another example, this disclosure may provide an adaptive EMA threshold, where an exponential moving average may be used for boundary detection in the transformer context (e.g., EMA thresholds used for transformer boundary detection). As another example, this disclosure may provide dual-criterion boundary detection, such as EMA threshold plus Fiedler zero-crossings, as opposed to fixed or attention-based boundary detection. As another example, this disclosure may provide power-law resource allocation, such as with configurable rho for domain-specific optimization, and/or for deterministic pre-computation. As another example, this disclosure may provide coherence-triggered resurrection, which may be based on pre-computed relationships (e.g., coherence threshold, coherence links, semantic relationships, etc.), not query-time attention (e.g., not attention score). As another example, this disclosure may provide coherence-triggered queries. As another example, this disclosure may provide bidirectional coherence links (e.g., between memory fidelity levels), such as an explicit graph with quantified semantic relationships. As another example, this disclosure may provide a three tier memory architecture, such as active/summary/dormant with coherence-based transitions, as opposed to two tiers (e.g., active/compressed). As another example, this disclosure may provide a summary aggregation layer, such as an intermediate tier for gradual context expansion. As another example, this disclosure may provide dual-path resurrection, where dormant can activate via high-fidelity or summary tier. As another example, this disclosure may provide learned decompression, where expansion networks may reconstruct from summaries. As another example, this disclosure may provide unified response integration, which may seamlessly combine matched and resurrected content. As another example, this disclosure may provide a shift to layer-specific multi-scale surprise plus UNC weighting (e.g., combined with uncertainty and coherence components (e.g., layer-specific novelty computation)). As another example, this disclosure may provide computation of three-component UNC score with trainable weights, enables training-time optimization of boundary detection, layer-specific multi-scale novelty and UNC three-component combination and trainable weights, where a novelty component may aggregate layer-specific information content from multiple transformer layers (e.g., early, middle, late), capturing multi-scale representation changes, where this may be computed during training, not just inference. Therefore, this disclosure may provide a multi-scale aggregation and trainable weights combination. This disclosure may provide for explicit coherence links with semantic relations, coherence-triggered (e.g., as opposed to attention) retrieval, maintaining of explicit graph edges (e.g., coherence links) that may encode semantic relationships between dormant low-UNC units and active high-UNC units, where retrieval may be triggered by coherence threshold, not attention score. This disclosure may provide coherence-based methods that may use graph structure for data representation, not attention computation.

In some embodiments, there may be provided a computer-implemented method for hierarchical attention in transformer-based language models, the method configured to improve computational efficiency and memory utilization. The method may include (a) computing, for each memory unit u of a plurality of memory units in a hierarchical memory structure, the following: (i) an uncertainty component, Uncertainty(u), derived from entropy of attention probability distributions across the memory unit; (ii) a novelty component, Novelty(u), derived from layer-specific information content measurements computed independently at each transformer layer, wherein the novelty component represents cumulative surprise across multiple representation scales; and (iii) a coherence component, Coherence(u), derived from graph-based connectivity analysis measuring structural relationships between memory units of the plurality of memory units in the hierarchical memory structure; (b) combining the uncertainty, novelty, and coherence components using trainable weights α, β, and γ to produce a unified UNC attention score, UNC(u), for each memory unit u, according to: UNC(u)=α×Uncertainty(u)+β×Novelty(u)+γ×Coherence(u), wherein the weights α, β, and γ are optimizable parameters; (c) allocating computational and storage resources to each memory unit u based on its UNC attention score according to an inverse power-law allocation formula: A(s)=k×(1/s\hat{ }ρ), where s is the UNC attention score, k is a normalization constant, and p is a tunable exponent in the range [0.5, 2.0]; and (d) dynamically adjusting memory unit boundaries of the hierarchical memory structure using an adaptive threshold, threshold(t), computed via exponential moving average of historical UNC attention scores according to the following: threshold(t)=λ×UNC(t)+(1−λ)×threshold(t−1), wherein 2 is an adaptation rate; and wherein the method enables selective retention and prioritized processing of the plurality of memory units based on the combined uncertainty, novelty, and coherence components, thereby improving computational efficiency compared to uniform attention mechanisms (see, e.g., modules 100-106 and operations 200-214). In some embodiments, the uncertainty component is computed as Shannon entropy of attention weights according to the following: Uncertainty(u)=−Σp(a)×log(p(a)), where p(a) represents the attention probability distribution over tokens within the memory unit u (see, e.g., module 100 and operation 202). Additionally or alternatively, in some embodiments, the novelty component is computed by aggregating layer-specific information content measurements from at least three distinct transformer layers, wherein each layer-specific information content measurement captures surprise at a different representation granularity (see, e.g., module 101 and operations 203-205). Additionally or alternatively, in some embodiments, the coherence component is computed from spectral analysis of a token similarity graph, specifically using a Fiedler vector computed via power iteration on a sparse k-nearest-neighbor graph Laplacian (see, e.g., module 102 and operations 206-209). Additionally or alternatively, in some embodiments, the weights α, β, and γ are optimized during training via gradient descent to minimize a task-specific loss function while maintaining the following: α+β+γ=1 (see, e.g., module 103 and operation 210). Additionally or alternatively, in some embodiments, a default weight configuration for the weights α, β, and γ is the following: α=0.3, β=0.4, γ=0.3, empirically optimized for long-document processing tasks (see, e.g., module 103). Additionally or alternatively, in some embodiments, the tunable exponent p is set to: 1.0 for balanced allocation; a value below 1.0 for gentler resource distribution; and a value above 1.0 for aggressive prioritization of high-UNC memory units (see, e.g., module 106 and operations 401 and 404). Additionally or alternatively, in some embodiments, the method may also include maintaining explicit bidirectional coherence links between memory units of different fidelity levels, wherein low-UNC memory units are stored in a dormant state with coherence links to high-UNC neighbors enabling selective activation upon coherence-triggered queries (see, e.g., modules 109 and 110, components 505 and 508, and operations 603-607). Additionally or alternatively, in some embodiments, the method achieves computational complexity of O(n log n) for processing a sequence of n tokens through use of sparse graph construction and power iteration, for example, as compared to O(n²) complexity (see, e.g., operation 206).

In some embodiments, there may be provided a computer-implemented method for hierarchical attention in neural network architectures, the method configured to improve computational efficiency and memory utilization. The method may include (a) computing, for each memory unit u of a plurality of memory units in a hierarchical memory structure, an importance score by combining two or more distinct importance signals, wherein the distinct importance signals capture complementary aspects of content relevance and comprise at least two of the following: (i) an uncertainty component derived from entropy, confidence, variance, or statistical distribution analysis of attention patterns, gate activations, or state representations; (ii) a novelty component derived from layer-specific, position-specific, abstraction-level-specific, or time-specific information content, surprise, or divergence measurements; (iii) a coherence component derived from graph-based, structure-based, similarity-based, or relationship-based connectivity analysis; and (iv) any other distinct importance signal capturing a different aspect of content relevance; (b) allocating computational and storage resources to each memory unit u based on its importance score according to a monotonically decreasing allocation function; and (c) dynamically adjusting memory unit boundaries using an adaptive threshold mechanism; wherein the method enables selective retention and prioritized processing of the plurality of memory units based on the combined importance signals, thereby improving computational efficiency compared to uniform processing mechanisms. In some embodiments, the distinct importance signals may include (i) an uncertainty component Uncertainty(u) derived from Shannon entropy of attention probability distributions or equivalent confidence measures from gating mechanisms; (ii) a novelty component Novelty(u) derived from layer-specific information content aggregation; and (iii) a coherence component Coherence(u) derived from graph Laplacian Fiedler vector analysis or equivalent structural connectivity measures, where, in some such embodiments, the importance score may be computed via linear combination: UNC(u)=α×Uncertainty(u)+β×Novelty(u)+γ×Coherence(u), wherein α, β, and γ are trainable weights satisfying α+β+γ=1.0. In some embodiments, resource allocation may be computed via inverse power-law formula: A(s)=k×(1/s\hat{ }ρ), where s is the importance score, k is a normalization constant, and ρ is a tunable exponent in range [0.5, 2.0]. In some embodiments, the adaptive threshold may be computed via exponential moving average: threshold(t)=λ×Score(t)+(1−λ)×threshold(t−1), wherein λ0 is an adaptation rate in range [0.05, 0.2]. In some embodiments, memory unit boundaries may be detected using dual-criterion detection combining: (a) statistical criterion where importance score exceeds adaptive threshold, and (b) structural criterion based on graph-theoretic analysis or state transition detection. In some embodiments, the hierarchical memory structure may include three tiers: (a) a high-fidelity tier storing high-importance content at full precision; (b) a medium-fidelity tier storing medium-importance content with 2-4× compression; and (c) a low-fidelity tier storing low-importance content with 10-50× compression and resurrection capability. In some embodiments, the method may also include maintaining explicit bidirectional relationships between memory units across tiers, wherein lower-tier memory units may be selectively resurrected when relationship strength to active content exceeds a resurrection threshold. In some embodiments, the method may achieve computational complexity of O(n log n) or better for processing a sequence of n elements, compared to O(n²) complexity of uniform processing mechanisms. In some embodiments, the neural network architecture may include a transformer architecture, and wherein the distinct importance signals may be derived at least in part from attention probability distributions. In some embodiments, the neural network architecture may include a recurrent neural network or state space model, and wherein the distinct importance signals may be derived at least in part from gating mechanism outputs, selective coefficients, hidden state dynamics, or state transition magnitudes. In some embodiments, the neural network architecture may be integrated into a retrieval-augmented generation (RAG) system, wherein memory units may include retrieved document chunks and the hierarchical memory management may enable selective context retention and prioritized augmentation. In some embodiments, one or more of the following may be trainable parameters: importance signal combination weights, threshold adaptation parameters, allocation function parameters, relationship strength functions, and tier boundary thresholds. In some embodiments, memory units may correspond to temporal segments or state snapshots in a continuous-state architecture, and wherein memory unit boundaries may be determined by significant state transitions, gate activation thresholds, or time-based windowing rather than discrete token boundaries. In some embodiments, the combining may include combining the two or more distinct importance signals through weighted aggregation, learned combination functions, or attention-based fusion. In some embodiments, the monotonically decreasing allocation function may include one or more of the following: power-law functions, exponential functions, logarithmic functions, learned allocation functions, or piecewise allocation functions. In some embodiments, the adaptive threshold mechanism may include one of: exponential moving average; sliding window statistics; Bayesian tracking; learned threshold functions; or any mechanism adapting to historical score distributions. In some embodiments, the memory unit boundaries may include one of: discrete token boundaries; temporal segment boundaries; or state transition points.

In some embodiments, there may be provided a system for hierarchical processing in neural network architectures. The system may include (a) an importance computation module configured to compute importance scores for memory units by combining two or more distinct importance signals capturing complementary aspects of content relevance through weighted or learned combination mechanisms; (b) a resource allocation module configured to allocate computational and storage resources to memory units based on importance scores using any monotonically decreasing allocation function; (c) a boundary detection module configured to segment input into memory units using adaptive thresholding mechanisms, wherein segmentation may be based on discrete boundaries, temporal windows, state transitions, or any other suitable partitioning; (d) a hierarchical memory module configured to manage multi-tier storage with selective retention based on importance, comprising at least a high-fidelity tier and a low-fidelity tier; (e) a cross-tier relationship module configured to maintain relationships between memory units across tiers, enabling selective retrieval and resurrection of lower-tier content based on relationship strength; and (f) one or more processors configured to execute the above modules on any neural network architecture producing importance-relevant signals, comprising attention distributions, gating mechanism outputs, hidden state representations, selective coefficients, or memory access patterns.

In some embodiments, there may be provided a non-transitory computer-readable medium storing instructions that, when executed by one or more processors, cause the processors to perform a method for hierarchical processing in neural network architectures. The method may include computing importance scores for memory units by combining two or more distinct importance signals capturing complementary aspects of content relevance; allocating resources based on importance scores using a monotonically decreasing allocation function; dynamically adjusting memory unit boundaries using adaptive thresholding; managing hierarchical memory with selective retention; and maintaining cross-tier relationships enabling selective retrieval and resurrection.

This disclosure contemplates numerous architectural variations, all within the scope of the claims, including, but not limited to, transformer variations, recurrent neural network variations, state space model variations, memory-augmented architectures, hybrid and emerging architectures, retrieval-augmented variations, deployment variations, and/or the like. For example, transformer variations may include, but are not limited to, standard decoder-only transformers (e.g., GPT-style), encoder-decoder transformers (e.g., T5-style, BART-style), encoder-only transformers (e.g., BERT-style), multi-query attention variants, grouped-query attention variants, mixture of Experts transformer variants, sparse transformer variants, linear attention variants, flash attention implementations, any future transformer architecture variants, and/or the like. Recurrent neural network variations may include, but are not limited to, long short-term memory (“LSTM”) with gating mechanisms, gated recurrent units (“GRU”), peephole connection variants, bidirectional recurrent networks, stacked recurrent networks; recurrent neural networks (“RNNs”) with attention augmentation, and/or the like. In these architectures, importance signals may be derived from gate activations, hidden state dynamics, or cell state changes rather than attention distributions. State space model variations may include, but are not limited to, Mamba and selective state space architectures; S4 models, S5 and diagonal state space variants, hybrid state space model (“SSM”)-attention architectures, linear recurrence with selective gating, and/or the like. In these architectures, importance signals may be derived from selective gating coefficients, state update magnitudes, or output gate activations rather than explicit attention matrices. Memory-augmented architectures may include, but are not limited to, differentiable neural computers; neural Turing machines; memory networks and end-to-end memory networks, Hopfield networks with modern energy functions, any suitable architecture with external memory access, and/or the like. In these architectures, importance signals may be derived from memory read/write attention, addressing mechanisms, or memory utilization patterns. Hybrid and emerging architectures may include, but are not limited to, transformer plus RNN hybrids, hybrid local plus global attention; convolutional neural network (“CNN”) plus attention hybrids, graph neural network plus attention hybrids, multi-modal architectures, liquid neural networks, Kolmogorov-Arnold networks, spiking neural networks, quantum neural network architectures, any future neural architecture producing signals indicative of content importance, and/or the like. Retrieval-augmented variations may include, but are not limited to, dense retrieval with importance scoring, sparse retrieval (e.g., BM25, TF-IDF) with coherence-link ranking, hybrid dense-sparse retrieval, learned retrieval with trainable score combination, multi-index retrieval, hierarchical retrieval, any retrieval-augmented generation (“RAG”) pipeline, and/or the like. Deployment variations may include, but are not limited to, single-device implementations, distributed implementations across GPU/TPU clusters, edge device implementations, embedded system implementations, cloud-native implementations, serverless implementations, quantum-classical hybrid implementations, FPGA/ASIC accelerated implementations, and/or the like. All architectural variations and their combinations are explicitly within the scope of the present disclosure.

This disclosure contemplates various mathematical formulations. The specific mathematical formulations in the illustrative embodiments should be understood as specific instances of more general mathematical principles: For example, with respect to importance scoring, a general principle may be Score(u)=COMBINE(signal_1(u), signal_2(u), . . . , signal_N(u)), where COMBINE may be any function combining two or more distinct importance signals capturing complementary aspects of content relevance, where the signals need not be statistically independent, as they may need only capture different aspects of importance (e.g., confidence, surprise, structural role), whereas a specific instances may be (UNC): UNC(u)=α×Uncertainty(u)+β×Novelty(u)+γ×Coherence(u), where the disclosure may encompass any number of components (e.g., 2, 3, . . . N) and any combination function (e.g., linear, learned, gated, attention-based, multiplicative, etc.). With respect to resource allocation, a general principle may be allocation(s)=f(s), where f may be any monotonically decreasing function of importance score s, whereas a specific instance may be A(s)=k×(1/s\hat{ }ρ), where the disclosure may encompass power-law, exponential, logarithmic, learned, piecewise, and any other monotonically decreasing allocation function. With respect to adaptive thresholding, a general principle may be threshold(t)=ADAPT(score(t), history), where ADAPT may be any function adapting threshold based on score distribution, whereas a specific instance may be threshold(t)=λ×score(t)+(1−λ)×threshold(t−1), where the disclosure may encompass EMA, sliding window, Kalman, Bayesian, learned, and/or any other adaptive mechanism. With respect to memory unit definition, a general principle may be a “memory unit” as used herein that may refer to any discrete or quasi-discrete segment of processed content that can be assigned an importance score and managed within the hierarchical memory structure, where memory units may encompass: (i) token sequences or chunks in transformer architectures; (ii) temporal segments or time windows in recurrent architectures; (iii) state snapshots or state-change intervals in state space models; (iv) memory slots or addressed regions in memory-augmented networks; (v) retrieved document chunks in retrieval-augmented systems; (vi) any other discretizable or quasi-discretizable unit of processed content, and/or the like. For continuous-state architectures (e.g., LSTMs, SSMs, liquid neural networks, etc.), memory unit boundaries may correspond to significant state transitions, gate activation thresholds, time-based windows, or learned segmentation points rather than hard token boundaries. The hierarchical memory management principles may apply regardless of how content is segmented into manageable units. With respect to importance signal sources, a general principle may be that importance signals may be derived from any source indicative of content relevance, including but not limited to: (i) attention distributions (e.g., in transformer architectures); (ii) gate activations (e.g., in LSTM, GRU, or gated architectures); (iii) selective coefficients (e.g., in Mamba and selective SSMs); (iv) state update magnitudes (e.g., in any stateful architecture); (v) memory access patterns (e.g., in memory-augmented networks); (vi) retrieval scores (e.g., in RAG systems); (vii) any other signal correlated with content importance, and/or the like. This disclosure may not be limited to architectures producing explicit N×N attention matrices. With respect to cross-tier relationships, a general principle may be that links=RELATE(units, strengths, types), where RELATE may establish relationships between memory units across tiers using any suitable method. Relationships may be symmetric or asymmetric, typed or untyped, weighted or binary. With respect to cross-tier relationships, a specific instance may be bidirectional coherence links with strength∈[0,1] and types ∈{causal, temporal, referential, thematic}. All general principles and their specific instantiations are within the scope of this disclosure.

### Additional Disclosure

One, some, or all of the processes described with respect to FIGS. 1-6 and otherwise may each be partially or entirely implemented by software, but may also be implemented in hardware, firmware, or any combination of software, hardware, and firmware. Instructions for performing these processes may also be embodied as machine-or computer-readable code recorded on a machine-or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of FIG. 1A). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a central network controller device to a router device or from a data device to any network device. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure (e.g., any or each module of system 1) may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of any suitable system of the disclosure (e.g., system 1, system 199, system 599, etc.) may be stored in or otherwise accessible to a subsystem (e.g., subsystem 20) in any suitable manner (e.g., in memory 13 (e.g., as at least a portion of application 19a and/or model 19m)). Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip). At least a portion of one or more of the modules of any suitable system of the disclosure (e.g., system 1) may be stored in or otherwise accessible to any suitable components in any suitable manner. Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip).

Any or each module of any suitable system of the disclosure (e.g., system 1, system 199, system 599, etc.) may be a dedicated system implemented using one or more expansion cards adapted for various bus standards. For example, all of the modules may be mounted on different interconnected expansion cards or all of the modules may be mounted on one expansion card. With respect to system 1, by way of example only, modules of system 1 may interface with a motherboard or processor assembly 12 (e.g., of subsystem 20) through an expansion slot (e.g., a peripheral component interconnect (“PCI”) slot or a PCI express slot). Alternatively, modules of system 1 need not be removable but may include one or more dedicated modules that may include memory (e.g., RAM) dedicated to the utilization of the module. In other embodiments, modules of system 1 may be at least partially integrated into a subsystem (e.g., subsystem 20 (e.g., a server)). For example, a module of system 1 may utilize a portion of memory 13 of a subsystem. Any or each module of system 1 may include its own processing circuitry and/or memory. Alternatively, any or each module of system 1 may share processing circuitry and/or memory with any other module of system 1 and/or processor assembly 12 and/or memory assembly 13 of a subsystem (e.g., subsystem 20).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As may be used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some embodiments, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

While there have been described systems, methods, and computer-readable media for providing hierarchical attention in transformer-based models, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” “roll” and “pitch” and “yaw,” “clockwise” and “counter-clockwise,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

1. A computer-implemented method for hierarchical attention in neural network architectures, the method configured to improve computational efficiency and memory utilization, comprising:
(a) computing, for each memory unit u of a plurality of memory units in a hierarchical memory structure, an importance score by combining two or more distinct importance signals, wherein the distinct importance signals capture complementary aspects of content relevance and comprise at least two of the following:
(i) an uncertainty component derived from entropy, confidence, variance, or statistical distribution analysis of attention patterns, gate activations, or state representations;
(ii) a novelty component derived from layer-specific, position-specific, abstraction-level-specific, or time-specific information content, surprise, or divergence measurements;
(iii) a coherence component derived from graph-based, structure-based, similarity-based, or relationship-based connectivity analysis; and
(iv) any other distinct importance signal capturing a different aspect of content relevance;
(b) allocating computational and storage resources to each memory unit u based on its importance score according to a monotonically decreasing allocation function; and
(c) dynamically adjusting memory unit boundaries using an adaptive threshold mechanism;
wherein the method enables selective retention and prioritized processing of the plurality of memory units based on the combined importance signals, thereby improving computational efficiency compared to uniform processing mechanisms.

2. The method of claim 1, wherein the distinct importance signals comprise:
(i) an uncertainty component Uncertainty(u) derived from Shannon entropy of attention probability distributions or equivalent confidence measures from gating mechanisms;
(ii) a novelty component Novelty(u) derived from layer-specific information content aggregation; and
(iii) a coherence component Coherence(u) derived from graph Laplacian Fiedler vector analysis or equivalent structural connectivity measures.

3. The method of claim 2, wherein the importance score is computed via linear combination: UNC(u)=x×Uncertainty(u)+β×Novelty(u)+γ×Coherence(u), wherein α, β, and γ are trainable weights satisfying α+β+γ=1.0.

4. The method of claim 1, wherein resource allocation is computed via inverse power-law formula: A(s)=k×(1/s\hat{ }ρ), where s is the importance score, k is a normalization constant, and ρ is a tunable exponent in range [0.5, 2.0].

5. The method of claim 1, wherein the adaptive threshold is computed via exponential moving average: threshold(t)=λ×Score(t)+(1−λ)×threshold(t−1), wherein λ is an adaptation rate in range [0.05, 0.2].

6. The method of claim 1, wherein memory unit boundaries are detected using dual-criterion detection combining:
(a) statistical criterion where importance score exceeds adaptive threshold, and
(b) structural criterion based on graph-theoretic analysis or State transition detection.

7. The method of claim 1, wherein the hierarchical memory structure comprises three tiers:
(a) a high-fidelity tier storing high-importance content at full precision;
(b) a medium-fidelity tier storing medium-importance content with 2-4× compression; and
(c) a low-fidelity tier storing low-importance content with 10-50× compression and resurrection capability.

8. The method of claim 1, further comprising maintaining explicit bidirectional relationships between memory units across tiers, wherein lower-tier memory units are selectively resurrected when relationship strength to active content exceeds a resurrection threshold.

9. The method of claim 1, wherein the method achieves computational complexity of O(n log n) or better for processing a sequence of n elements, compared to O(n²) complexity of uniform processing mechanisms.

10. The method of claim 1, wherein the neural network architecture comprises a transformer architecture, and wherein the distinct importance signals are derived at least in part from attention probability distributions.

11. The method of claim 1, wherein the neural network architecture comprises a recurrent neural network or state space model, and wherein the distinct importance signals are derived at least in part from gating mechanism outputs, selective coefficients, hidden state dynamics, or state transition magnitudes.

12. The method of claim 1, integrated into a retrieval-augmented generation (“RAG”) system, wherein memory units comprise retrieved document chunks and the hierarchical memory management enables selective context retention and prioritized augmentation.

13. The method of claim 1, wherein one or more of the following are trainable parameters: importance signal combination weights, threshold adaptation parameters, allocation function parameters, relationship strength functions, and tier boundary thresholds.

14. The method of claim 1, wherein memory units correspond to temporal segments or state snapshots in a continuous-state architecture, and wherein memory unit boundaries are determined by significant state transitions, gate activation thresholds, or time-based windowing rather than discrete token boundaries.

15. The method of claim 1, wherein the combining comprises combining the two or more distinct importance signals through weighted aggregation, learned combination functions, attention-based fusion, or any other suitable combination method.

16. The method of claim 1, wherein the monotonically decreasing allocation function comprises one or more of the following:
power-law functions, exponential functions, logarithmic functions, learned allocation functions, or piecewise allocation functions.

17. The method of claim 1, wherein the adaptive threshold mechanism comprises one of:
exponential moving average;
sliding window statistics;
Bayesian tracking;
learned threshold functions; or
any other mechanism adapting to historical score distributions.

18. The method of claim 1, wherein the memory unit boundaries comprise one of:
discrete token boundaries;
temporal segment boundaries;
state transition points; or
any other suitable segmentation.

19. A system for hierarchical processing in neural network architectures, comprising:
(a) an importance computation module configured to compute importance scores for memory units by combining two or more distinct importance signals capturing complementary aspects of content relevance through weighted or learned combination mechanisms;
(b) a resource allocation module configured to allocate computational and storage resources to memory units based on importance scores using any monotonically decreasing allocation function;
(c) a boundary detection module configured to segment input into memory units using adaptive thresholding mechanisms, wherein segmentation may be based on discrete boundaries, temporal windows, state transitions, or any other suitable partitioning;
(d) a hierarchical memory module configured to manage multi-tier storage with selective retention based on importance, comprising at least a high-fidelity tier and a low-fidelity tier;
(e) a cross-tier relationship module configured to maintain relationships between memory units across tiers, enabling selective retrieval and resurrection of lower-tier content based on relationship strength; and
(f) one or more processors configured to execute the above modules on any neural network architecture producing importance-relevant signals, comprising attention distributions, gating mechanism outputs, hidden state representations, selective coefficients, or memory access patterns.

20. A non-transitory computer-readable medium storing instructions that, when executed by one or more processors, cause the processors to perform a method for hierarchical processing in neural network architectures, the method comprising:
computing importance scores for memory units by combining two or more distinct importance signals capturing complementary aspects of content relevance;
allocating resources based on importance scores using a monotonically decreasing allocation function;
dynamically adjusting memory unit boundaries using adaptive thresholding; managing hierarchical memory with selective retention; and
maintaining cross-tier relationships enabling selective retrieval and resurrection.

21-29. (canceled)
